(19) United States
(12) Patent Application Publication
(10) Pub. No.: US 2025/0179668 A1
(43) Pub. Date: Jun. 5, 2025

(54) PROCESSES FOR FORMING MULTIMETALLIC ALLOY NANOSTRUCTURES

(71) Applicant: Honda Motor Co., Ltd., Tokyo (JP)

(72) Inventors: Shutang CHEN, Livermore, CA (US); Yiman ZHANG, San Jose, CA (US); Gugang CHEN, Palo Alto, CA (US)

(21) Appl. No.: 18/525,582

(22) Filed: Nov. 30, 2023

(51) Int. Cl. C25B 11/046; H01M 4/92

(52) U.S. Cl. CPC C25B 11/046; H01M 4/921

(57) ABSTRACT

Aspects of the present disclosure generally relate to processes for forming multimetallic alloy nanostructures. In an aspect, a process for forming hollow multimetallic nanostructures is provided. The process includes reacting a first mixture comprising a copper-amine, a phosphine, and a nickel-amine to form Ni—Cu polyhedral nanoparticles; and reacting a second mixture comprising the Ni—Cu polyhedral nanoparticles and a platinum-amine to form Pt—Ni—Cu polyhedral nanoparticles. The process further includes reacting a third mixture comprising the Pt—Ni—Cu polyhedral nanoparticles and a Group 8-11 metal-amine to form Pt—Ni—Cu-M polyhedral nanoparticles, M is a Group 8-11 metal that is different from Pt, Ni, and Cu. The process further includes reacting a fourth mixture comprising the Pt—Ni—Cu-M polyhedral nanoparticles and an acid to form hollow multimetallic nanostructures.

### FIELD

Aspects of the present disclosure generally relate to processes for forming multimetallic alloy nanostructures.

### BACKGROUND

Platinum (Pt) and its alloys are widely used as fuel cell electrode materials due to their exceptional catalytic performance in, for example, oxygen reduction reactions. While platinum, platinum-nickel, and other Pt-based alloys alternatives demonstrate improved activity compared to typical catalysts, their limited durability, high cost, and limited chemical resistance to corrosion constrains their application as fuel cell electrode materials in corrosive electrolytes. Multimetallic nanoparticles, such as nanoparticles containing four metal elements (quaternary alloy nanoparticles), have been investigated for their use as electrocatalysts in fuel cells.

Achieving precise control over the nucleation and growth kinetics of quaternary alloy hollow nanocrystals, particularly when dealing with four metal precursors with differing reduction potentials, is challenging. Moreover, the quaternary alloy hollow nanocrystals formed by conventional methods lack the durability and stability needed for catalysis.

There is a need for new and improved processes for forming multimetallic alloy nanoparticles.

### SUMMARY

Aspects of the present disclosure generally relate to processes for forming multimetallic alloy nanostructures. The multimetallic alloy nanostructures can be in the form of nanoparticles, nanoframes, or combinations thereof. Unlike conventional methods for forming multimetallic alloy nanostructures, aspects described herein can enable control over the nucleation and growth of the multimetallic alloy nanostructures. Further, the multimetallic alloy nanostructures can show excellent durability and stability as catalysts.

In an aspect, a process for forming hollow multimetallic nanostructures is provided. The process includes reacting a first mixture comprising a copper-amine, a phosphine, and a nickel-amine to form Ni—Cu polyhedral nanoparticles; and reacting a second mixture comprising the Ni—Cu polyhedral nanoparticles and a platinum-amine to form Pt—Ni—Cu polyhedral nanoparticles. The process further includes reacting a third mixture comprising the Pt—Ni—Cu polyhedral nanoparticles and a Group 8-11 metal-amine to form Pt—Ni—Cu-M polyhedral nanoparticles, M is a Group 8-11 metal that is different from Pt, Ni, and Cu. The process further includes reacting a fourth mixture comprising the Pt—Ni—Cu-M polyhedral nanoparticles and an acid to form hollow multimetallic nanostructures.

In another aspect, a process for forming hollow multimetallic nanostructures is provided. The process includes reacting a first mixture comprising a copper-amine, a phosphine, and a nickel-amine to form Ni—Cu polyhedral nanoparticles, the first mixture having: a molar ratio of the copper-amine to the phosphine that is from about 1000:1 to about 50:1; and a molar ratio of the nickel-amine to the copper-amine that is from about 99:1 to about 1:1. The process further includes reacting a second mixture comprising the Ni—Cu polyhedral nanoparticles and a platinum-amine at a temperature that is from about 80° C. to about 320° C. to form Pt—Ni—Cu polyhedral nanoparticles, the second mixture having a molar ratio of the Ni—Cu polyhedral nanoparticles to platinum-amine that is from about 500:1 to about 1:50. The process further includes reacting a third mixture comprising the Pt—Ni—Cu polyhedral nanoparticles and a Group 8-11 metal-amine at a temperature that is from about 80° C. to about 320° C. to form Pt—Ni—Cu-M polyhedral nanoparticles, the third mixture having a molar ratio of the Pt—Ni—Cu polyhedral nanoparticles to the Group 8-11 metal-amine that is from about 500:1 to about 1:10, and M is a Group 8-11 metal that is different from Pt, Ni, and Cu. The process further includes reacting a fourth mixture comprising the Pt—Ni—Cu-M polyhedral nanoparticles and an acid at a temperature that is from about 15° C. to about 100° C. to form hollow multimetallic nanostructures, the fourth mixture having a molar ratio of the Pt—Ni—Cu-M polyhedral nanoparticles to acid that is from about 100:1 to about 1:100, wherein: the hollow multimetallic nanostructures comprise hollow Pt—Ni—Cu-M polyhedral nanoparticles; and the hollow Pt—Ni—Cu-M polyhedral nanoparticles have an average particle size that is from about 20 nm to about 500 nm

In another aspect, a process for forming quaternary multimetallic alloy nanoframes is provided. The process includes reacting a first mixture comprising a copper-amine, a phosphine, and a nickel-amine to form Ni—Cu polyhedral nanoparticles; and reacting a second mixture comprising the Ni—Cu polyhedral nanoparticles and a platinum-amine at a temperature that is from about 150° C. to about 300° C. to form Pt—Ni—Cu polyhedral nanoparticles. The process further includes reacting a third mixture comprising the Pt—Ni—Cu polyhedral nanoparticles and a Group 8-11 metal-amine at a temperature that is from about 150° C. to about 300° C. to form Pt—Ni—Cu-M polyhedral nanoparticles, M is a Group 8-11 metal selected from the group consisting of Fe, Ru, Os, Co, Rh, Ir, Pd, Ag, and Au. The process further includes reacting a fourth mixture comprising the Pt—Ni—Cu-M polyhedral nanoparticles and an acid at a temperature that is from about 15° C. to about 80° C. to form quaternary multimetallic alloy nanoframes, wherein: the quaternary multimetallic alloy nanoframes comprise Pt—Ni—Cu-M polyhedral nanoframes; a first mass % of the Group 8-11 metal in the Pt—Ni—Cu-M polyhedral nanoparticles is less than a second mass % of the Group 8-11 metal in the Pt—Ni—Cu-M polyhedral nanoframes; and wherein: the Pt—Ni—Cu-M polyhedral nanoframes have an average particle size that is from about 40 nm to about 350 nm; the Pt—Ni—Cu-M polyhedral nanoframes comprise rhombic dodecahedral nanoframes; or combinations thereof.

In another aspect, a process for forming quaternary multimetallic alloy nanoframes is provided. The process includes forming Ni—Cu polyhedral nanoparticles by: heating a first mixture comprising a copper-amine and an alkylphosphine to an injection temperature that is from about 80° C. to about 320° C., a molar ratio of the copper-amine to the alkylphosphine in the first mixture is from about 400:1 to about 100:1 introducing a nickel-amine to the heated mixture; and reacting the resultant mixture at a temperature that is from about 80° C. to about 320° C. to form the Ni—Cu polyhedral nanoparticles. The process further includes reacting a second mixture comprising the Ni—Cu polyhedral nanoparticles and a platinum-amine at a temperature that is from about 150° C. to about 300° C. to form Pt—Ni—Cu polyhedral nanoparticles, a molar ratio of the Ni—Cu polyhedral nanoparticles to platinum-amine in the second mixture is from about 100:1 to about 20:1. The process further includes reacting a third mixture comprising the Pt—Ni—Cu polyhedral nanoparticles and a Group 8-11 metal-amine at a temperature that is from about 150° C. to about 300° C. to form Pt—Ni—Cu-M polyhedral nanoparticles, M is a Group 8-11 metal selected from the group consisting of Au, Ag, Pd, Co, or Fe, a molar ratio of the Pt—Ni—Cu polyhedral nanoparticles to the Group 8-11 metal-amine in the third mixture is from about 50:1 to about 20:1. The process further includes reacting a fourth mixture comprising the Pt—Ni—Cu-M polyhedral nanoparticles and an acid to form quaternary multimetallic alloy nanoframes, a molar ratio of the Pt—Ni—Cu-M polyhedral nanoparticles to acid in the fourth mixture is from about 10:1 to about 1:50, wherein: the quaternary multimetallic alloy nanoframes comprises Pt—Ni—Cu-M polyhedral nanoframes; a first mass % of the Group 8-11 metal in the Pt—Ni—Cu-M polyhedral nanoparticles is less than a second mass % of the Group 8-11 metal in the Pt—Ni—Cu-M polyhedral nanoframes; and wherein: the Pt—Ni—Cu-M polyhedral nanoframes have an average particle size that is from about 20 nm to about 500 nm; the Pt—Ni—Cu-M polyhedral nanoframes comprise rhombic dodecahedral nanoframes; or combinations thereof.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1A is a flow chart showing selected operations of a process 100 for forming multimetallic alloy nanostructures according to at least one aspect of the present disclosure.

FIG. 1B is a transmission electron microscopy (TEM) image of example nickel-copper (Ni—Cu) solid nanoparticles according to at least one aspect of the present disclosure. (scale: 500 nm).

FIG. 1C is a TEM image of example platinum-nickel-copper (Pt—Ni—Cu) solid nanoparticles according to at least one aspect of the present disclosure. (scale: 500 nm).

FIG. 1D is a TEM image of example platinum-nickel-copper-gold (Pt—Ni—Cu—Au) solid nanoparticles according to at least one aspect of the present disclosure. (scale: 500 nm).

FIG. 1E is a TEM image of example platinum-nickel-copper-gold (Pt—Ni—Cu—Au) hollow nanoparticles according to at least one aspect of the present disclosure. (scale: 300 nm).

FIG. 2 is an overlay of X-ray diffraction (XRD) patterns of an example Ni—Cu solid polyhedral nanoparticles, example Pt—Ni—Cu solid nanoparticles, example Pt—Ni—Cu—Au solid polyhedral nanoparticles, and example Pt—Ni—Cu—Au hollow nanoparticles according to at least one aspect of the present disclosure.

FIG. 3A is a TEM image of example Pt—Ni—Cu—Au hollow nanoparticles according to at least one aspect of the present disclosure. (scale: 100 nm).

FIG. 3B is an elemental mapping image of example Pt—Ni—Cu—Au hollow nanoparticles, showing all four metal elements, according to at least one aspect of the present disclosure. (scale: 1 μm).

FIG. 3C is an elemental mapping image of the example Pt—Ni—Cu—Au hollow nanoparticles presented in FIG. 3B, showing only Pt metal (red), according to at least one aspect of the present disclosure. (scale: 1 μm).

FIG. 3D is an elemental mapping image of the example Pt—Ni—Cu—Au hollow nanoparticles presented in FIG. 3B, showing only Cu metal (blue), according to at least one aspect of the present disclosure. (scale: 1 μm).

FIG. 3E is an elemental mapping image of the example Pt—Ni—Cu—Au hollow nanoparticles presented in FIG. 3B, showing only Ni metal (green), according to at least one aspect of the present disclosure. (scale: 1 μm).

FIG. 3F is an elemental mapping image of the example Pt—Ni—Cu—Au hollow nanoparticles, presented in FIG. 3B, showing only Au metal (purple), according to at least one aspect of the present disclosure. (scale: 1 μm).

FIG. 4A is a scanning electron microscopy (SEM) image of example platinum-nickel-copper-silver (Pt—Ni—Cu—Ag) hollow nanoparticles according to at least one aspect of the present disclosure. (scale: 300 nm).

FIG. 4B is a SEM image of example platinum-nickel-copper-palladium (Pt—Ni—Cu—Pd) hollow nanoparticles according to at least one aspect of the present disclosure. (scale: 300 nm).

FIG. 4C is a zoomed-in version of the SEM image presented in FIG. 4B. (scale: 300 nm).

FIG. 4D is scanning electron microscopy (SEM) image of example platinum-nickel-copper-cobalt (Pt—Ni—Cu—Co) hollow nanoparticles according to at least one aspect of the present disclosure. (scale: 300 nm).

FIG. 5 is an overlay of XRD patterns of example Pt—Ni—Cu—Ag hollow nanoparticles, example Pt—Ni—Cu—Pd hollow nanoparticles, and example Pt—Ni—Cu—Co hollow nanoparticles according to at least one aspect of the present disclosure.

FIG. 6A is a TEM image of example Pt—Ni—Cu—Pd hollow nanoparticles supported on carbon according to at least one aspect of the present disclosure. (scale: 200 nm).

FIG. 6B is a TEM image of example Pt—Ni—Cu—Co hollow nanoparticles supported on carbon according to at least one aspect of the present disclosure. (scale: 200 nm).

FIG. 7A shows cyclic voltammetry curves of example Pt—Ni—Cu—Pd hollow nanoparticles supported on carbon according to at least one aspect of the present disclosure.

FIG. 7B shows cyclic voltammetry curves of example Pt—Ni—Cu—Co hollow nanoparticles supported on carbon according to at least one aspect of the present disclosure.

FIG. 7C shows linear sweeping voltammetry curves of example Pt—Ni—Cu—Pd hollow nanoparticles supported on carbon according to at least one aspect of the present disclosure.

FIG. 7D shows linear sweeping voltammetry curves of example Pt—Ni—Cu—Co hollow nanoparticles supported on carbon according to at least one aspect of the present disclosure.

### DETAILED DESCRIPTION

Aspects of the present disclosure generally relate to processes for forming multimetallic alloy nanostructures. The multimetallic alloy nanostructures can include four metals. When the multimetallic alloy nanostructures include four metals, the multimetallic alloy nanostructures can be referred to as quaternary alloy nanostructures. The multimetallic alloy nanostructures can be in the form of nanoparticles, nanoframes, or combinations thereof. The multimetallic alloy nanostructures can be single-phase alloys, dual-phase alloys, or combinations thereof. A single-phase alloy is a single composition, while a dual-phase alloy is a mixed composition comprising at least two compositions. Additionally, or alternatively, the multimetallic alloy nanostructures can be in the form of nanocrystals. In some non-limiting aspects, a multimetallic alloy nanostructure described herein can include at least four metal elements. In some aspects, multimetallic alloy nanostructures described herein can be regarded as high entropy alloys, where each metal element contributing no less than 10% of the multimetallic alloy. Additionally, or alternatively, multimetallic alloy nanostructures described herein can include four metal elements in an equiatomic or near equiatomic composition. In some aspects, one or more metal elements of the multimetallic alloy nanostructure can be less than 10% of the multimetallic alloy nanostructure. Multimetallic alloy nanostructures described herein can be utilized as catalysts in fuel cells to catalyze, for example, oxygen reduction reactions. The multimetallic alloy nanostructures show excellent durability and stability.

High entropy alloys (HEAs) are multimetallic alloy nanoparticles containing four or more metallic elements in close atomic proportions, and are candidates for energy conversion and storage. Beyond the challenges described above such as control over the nucleation and growth, most HEAs formed by conventional methods are composed of unevenly distributed alloys in the crystals and conventional methods lack precise control over the nucleation and growth kinetics of HEAs.

The use of headings is for purposes of convenience only and does not limit the scope of the present disclosure. Aspects described herein can be combined with other aspects.

As used herein, a “composition” can include component(s) of the composition, reaction product(s) of two or more components of the composition, and/or a remainder balance of remaining starting component(s). Compositions of the present disclosure can be prepared by any suitable mixing process.

As used herein, the term “nanoparticles”, “nanocrystals”, and “nanostructures” are used interchangeably such that reference to one includes reference to the other unless specified to the contrary or the context clearly indicates otherwise. For example, reference to “nanoparticles” includes reference to “nanoparticles”, “nanocrystals”, and “nanostructures”. The nanoparticles can be utilized as nanocatalysts.

As used herein, the term “nanoframe” refers to nanoparticles that are at least partially hollow. The nanoframes can be utilized as catalysts.

As described above, increased energy use and climate change concerns have spurred the rapid development of technology with low or even zero carbon emissions. One such technology is hydrogen fuel cells. Hydrogen fuel cells are highly efficient energy conversion technologies now used in a variety of vehicles, including automobiles, trucks, and future ocean-going freighters and aircraft. However, there is a pressing need to improve fuel cell technologies to meet energy demands, specifically by reducing Pt usage and maintaining high performance and durability over the long term.

Aspects of the present disclosure generally relate to processes for forming multimetallic alloy nanostructures. The multimetallic alloy nanostructures can include four metals such as platinum (Pt), nickel (Ni), copper (Cu), and a Group 8-11 metal that is different from Pt, Ni, or Cu. The multimetallic alloy nanostructure can include Pt—Ni—Cu-M polyhedral nanoparticles that are at least partially hollow and where M is the Group 8-11 metal that is different from Pt, Ni, or Cu. These polyhedral nanoparticles can be utilized as catalysts in fuel cells such as proton exchange membrane fuel cells (PEMFCs). As further described below, the catalytic performance of the supported catalysts formed by aspects described herein far exceed those catalysts commercially available such as Pt/C. For example, and in some aspects, carbon-supported multimetallic alloy nanostructures described herein can have mass activities that surpass the 2025 Department of Energy (DOE) target for electrocatalysts after 30,000 cycles (2025 DOE target:mass activity >0.44 A/mg(Pt) in PEMFCs) and that surpass the 2030 Department of Energy (DOE) target for electrocatalysts after 100,000 cycles (2030 DOE target:mass activity >0.44 A/mg(Pt) in PEMFCs). Multimetallic alloy nanostructures described herein can be utilized as a catalyst in, for example, electrochemical oxygen reduction reactions (ORR) and hydrogen evolution reactions, among other reactions. In such applications, the multimetallic alloy nanostructures can be integrated into a portion of, for example, a reactor, a fuel cell device such as a PEMFC device, or other devices useful for performing conversion reactions, among other applications. The enhanced performance and durability of catalysts formed by aspects described herein can meet the needs of heavy-duty fuel cell technology.

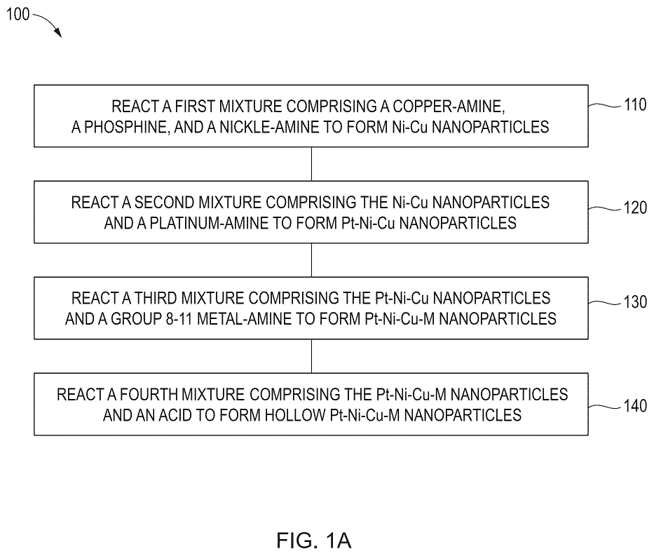

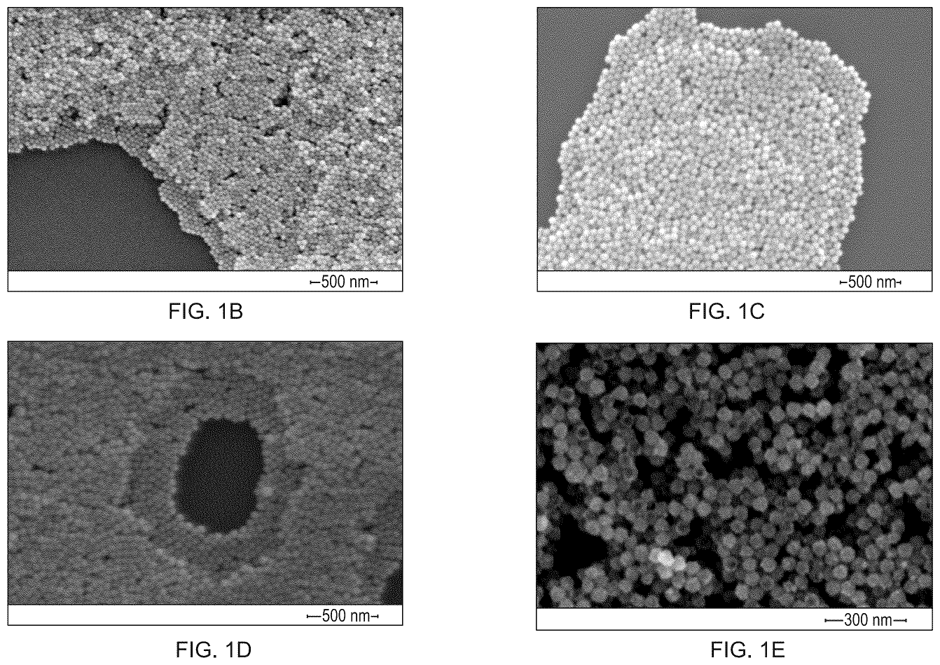

FIG. 1A is a flow chart showing selected operations of a process 100 for forming multimetallic alloy nanostructures according to at least one aspect of the present disclosure. Briefly, and in some aspects, processes described herein include creating active sites on nickel-copper (Ni—Cu) polyhedral nanoparticles, a platinum (Pt) ion treatment, a replacement of residual Ni or Cu atoms with transition metal atoms, and dissolving residual transition metal by acid treatment and forming hollow multimetallic nanostructures.

During process 100, metal-amines, such as such as a transition metal-amines, can be utilized as precursors to form the hollow multimetallic nanostructures. These metal-amines can be complexes, for example, metal-amine complexes. The metal-amine includes a transition metal, such as a Group 8-11 metal, such as such as iron (Fe), ruthenium (Ru), osmium (Os), cobalt (Co), rhodium (Rh), iridium (Ir), nickel (Ni), palladium (Pd), platinum (Pt), copper (Cu), silver (Ag), or gold (Au), such as Fe, Co, Ni, Pd, Pt, Cu, Ag, or Au. The metal-amine includes a nitrogen-containing compound. Such nitrogen-containing compounds include, e.g., primary amines, secondary amines, tertiary amines, or combinations thereof. The nitrogen-containing compounds can include an unsubstituted hydrocarbyl or a substituted hydrocarbyl (as described herein) bonded to the nitrogen of the nitrogen-containing compound, where the unsubstituted hydrocarbyl or substituted hydrocarbyl can be saturated or unsaturated, linear or branched, cyclic or acyclic, aromatic or non-aromatic. The nitrogen-containing compound can be an alkylamine. Illustrative, but non-limiting, examples of nitrogen-containing compounds include tetradecylamine (TDA), oleylamine (OLA), octadecylamine (ODA), hexadecylamine (HDA), dodecylamine (DDA), isomers thereof, derivatives thereof, or combinations thereof.

As used herein, the term “unsubstituted hydrocarbyl” refers to a group that consists of hydrogen and carbon atoms only. Illustrative, but non-limiting, examples of unsubstituted hydrocarbyl include an alkyl group having from 1 to 20 carbon atoms such as methyl, ethyl, n-propyl, isopropyl, n-butyl, iso-butyl, sec-butyl, and tert-butyl, pentyl, hexyl, heptyl, octyl, ethyl-2-hexyl, isooctyl, nonyl, n-decyl, isodecyl, or isomers thereof; a cycloaliphatic group having from 3 to 20 carbon atoms such as, for example, cyclopentyl or cyclohexyl; an aromatic group having from 6 to 20 carbon atoms such as, for example, phenyl or naphthyl; or any combination thereof. In some aspects, R¹ of Formula (I) can be a linear or branched alkenyl having from 1 to 20 carbon atoms, such as from 3 to 10 carbon atoms. The term “alkenyl” refers to a hydrocarbyl having at least one double bond. An illustrative, but non-limiting, example of alkenyl includes allyl (for example, —CH₂CH═CH₂).

As used herein, the term “substituted hydrocarbyl” refers to an unsubstituted hydrocarbyl in which at least one hydrogen of the unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOx (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

The metal-amines can be made from a Group 8-11 metal source that includes a Group 8-11 metal and one or more ligands such as halide (for example, I⁻, Br⁻, Cl⁻, or F⁻), acetylacetonate (O₂C₅H₇⁻), hydride (H⁻), SCN⁻, NO₂⁻, NO₃⁻, N₃⁻, OH⁻, oxalate (C₂O₄²⁻), H₂O, acetate (CH₃COO⁻), O₂⁻, CN⁻, OCN⁻, OCN⁻, CNO⁻, NH₂⁻, NH²⁻, NC⁻, NCS⁻, N(CN)₂⁻, pyridine (py), ethylenediamine (en), 2,2′-bipyridine (bipy), PPh₃, or combinations thereof. In some aspects, the metal source includes metal acetates, metal acetylacetonates, metal halides, metal nitrates, and/or other suitable metal species. The metal of the metal sources can be present in any suitable oxidation state with the ligand(s).

Illustrative, but non-limiting, examples of Ni metal sources can include nickel(II) (acetylacetonate) (Ni(acac)₂), nickel(II) chloride (NiCl₂, or hydrates thereof, for example, NiCl₂·6H₂O), nickel(II) acetate (Ni(CH₃CO₂)₂), nickel(II) nitrate (Ni(NO₃)₂), hydrides thereof, hydrates thereof, or combinations thereof, among others. Illustrative, but non-limiting, examples of Cu metal sources can include copper(II) (acetylacetonate) (Cu(acac)₂), copper (II) chloride (CuCl₂, or hydrates thereof, for example, CuCl₂·2H₂O), copper(II) acetate (Cu(CH₃CO₂)₂), copper(II) nitrate (Cu(NO₃)₂), hydrides thereof, hydrates thereof, or combinations thereof, among others.

Illustrative, but non-limiting examples of Pt metal sources can include platinum(II) acetylacetonate (Pt(C₅H₇O₂)₂ also referred to as Pt(acac)₂), hexachloroplatinic acid (or hydrates thereof, for example, H₂PtCl₆·6H₂O), platinum chloride (PtCl₄), potassium platinum(II) chloride (K₂PtCl₄), platinum(II) acetate (Pt(CH₃CO₂)₂), platinum(IV) acetate (Pt(CH₃CO₂)₄), sodium hexachloroplatinate hexahydrate (Na₂PtCl₆·6H₂O), platinum(III) nitrate (Pt(NO₃)₂), hydrides thereof, hydrates thereof, or combinations thereof, among others.

Illustrative, but non-limiting, examples of Au metal sources can include gold(III) chloride (AuCl₃, or hydrates thereof, for example, tetrachloroauric(III) acid trihydrate (HAuCl₄·3H₂O), gold(III) nitrate ((Au(NO₃)₃ or HAu(NO₃)₄·3H₂O), hydrides thereof, hydrates thereof, or combinations thereof, among others. Illustrative, but non-limiting, examples of Ag metal sources can include silver chloride (AgCl), silver nitrate (Ag(NO₃)), hydrides thereof, hydrates thereof, or combinations thereof, among others.

Illustrative, but non-limiting, examples of Pd metal sources can include palladium(II) (acetylacetonate) (Pd(acac)₂), palladium(II) chloride (PdCl₂, or hydrates thereof, for example, PdCl₂·2H₂O), palladium(II) acetate (Pd(CH₃CO₂)₂), palladium(II) nitrate (Pd(NO₃)₂), hydrides thereof, hydrates thereof, or combinations thereof, among others. Illustrative, but non-limiting, examples of Co metal sources can include cobalt(II) (acetylacetonate) (Co(acac)₂), cobalt(II) chloride (COCl₂, or hydrates thereof, for example, CoCl₂·6H₂O), Co(II) acetate (Co(CH₃CO₂)₂), cobalt(II) nitrate (Co(NO₃)₂), hydrides thereof, hydrates thereof, or combinations thereof, among others. Illustrative, but non-limiting, examples of Fe metal sources can include iron(III) (acetylacetonate) (Fe(acac)₃), iron(III) chloride (FeCl₃, or hydrates thereof), iron(II) acetate (Fe(CH₃CO₂)₃), iron(III) nitrate (Fe(NO₃)₃), hydrides thereof, hydrates thereof, or combinations thereof, among others.

The metal-amine can be formed by suitable methods such as reacting a mixture comprising a Group 8-11 metal salt and a nitrogen containing compound to form a Group 8-11 metal-amine (for example, copper-amine, nickel-amine, platinum-amine, gold-amine, etc.). The reaction temperature for forming the metal-amine can vary from about 40° C. to about 220° C., such as from about 50° C. to about 150° C. or about 200° C. The reaction time to form the metal-amine can be any suitable period, such as from about 1 minute to about 3 hours, such as about 5 minutes to about 1 hour. Any reasonable pressure can be used during formation of the metal-amine. Conditions effective to form the metal-amine (for example, copper-amine or nickel-amine) can include stirring, mixing, and/or agitation. Conditions can optionally include utilizing a non-reactive gas, such as N₂ and/or Ar. For example, a mixture of the metal source and the nitrogen-containing compound can be placed under these or other non-reactive gases to degas various components or otherwise remove oxygen from the reaction mixture. In some aspects, the metal-amine can be kept in the form of a stock solution/suspension for use in various operations of the process.

Unlike conventional methods for forming multimetallic alloy nanostructures, aspects described herein can enable control over the nucleation and growth kinetics of quaternary alloy hollow nanocrystals. Here, conventional synthetic strategies include mixing or injecting four different metal precursors together in a reaction flask. As a result, it is challenging to control seed nucleation and growth of nanoparticles. In contrast, aspects described herein can utilize a step-by-step process to control seed morphology and control growth rate. Here, nucleation and growth can be controlled by, for example, metal precursor amounts, reaction temperature, and/or oxidative potential of metal precursors (or metal ions). For example, aspects described herein can enable terminating a reaction and separating products at any suitable time based on, e.g., the size and morphology of seeds. With respect to reaction temperature, a higher reaction temperature can lead to faster nucleation of seeds and growth of nanoparticles. The oxidative potential of metal precursors (or metal ions) can also affect the nucleation of seeds and growth of nanoparticles, whereby a higher oxidative potential can lead to easier nucleation of seeds and growth at lower temperatures. Higher amounts of metal precursors can be utilized for faster nucleation of seeds, which in turn, can lead to a larger average particle size. That is, aspects described herein can enable control over seed morphology, growth rate of nanoparticles, and/or size of the nanoparticles grown.

Referring back to FIG. 1A, process 100 can begin with reacting a first mixture comprising a copper-amine, a phosphine, and a nickel-amine to form nickel-copper (Ni—Cu) polyhedral nanoparticles at operation 110. The polyhedral nanoparticles formed from operation 110 can be characterized as having active sites due to, for example, the number of faces or sides. For example, the polyhedral Ni—Cu nanoparticles can be dodecahedral nanoparticles but other polyhedral structures are contemplated such as rhombic, rhombic dodecahedral, hexagonal, or combinations thereof, among others.

Aspects of the copper-amine and the nickel-amine are described above with respect to the metal-amines. Illustrative, but non-limiting, examples of phosphines include alkylphosphines and/or arylphosphines such as trimethylphosphine, triethylphosphine, tripropylphosphine, tributylphosphine, tripentylphosphine, trihexylphosphine, trioctylphosphine, tricyclohexylphosphine, diethylphosphine, dibutylphosphine, diphenylphosphine, dimethylethylphosphine, triphenylphosphine, isomers thereof, derivatives thereof, and combinations thereof.

Operation 110 can include forming a mixture comprising the copper-amine and the phosphine. The mixture can be formed under conditions that include an operating temperature and a duration of time. The operating temperature can be set to about 400° C. or less, such as from about 50° C. to about 400° C., such as from about 75° C. to about 375° C., such as from about 100° C. to about 350° C., such as from about 125° C. to about 325° C., such as from about 150° C. to about 300° C., such as from about 175° C. to about 275° C., such as from about 200° C. to about 250° C., such as from about such as from about 200° C. to about 225° C. In some aspects, the operating temperature of conditions can be set to a temperature of about 100° C. to about 150° C. or from about 180° C. to about 320° C. Higher or lower temperatures can be used when appropriate. The time for forming the mixture can be about 1 min or more or about 24 h or less, such as from about 5 min to about 6 h, such as from about 10 min to about 1 h, though greater or lesser periods of time are contemplated. Conditions can include stirring, mixing, and/or agitating the mixture to ensure, e.g., homogeneity of the mixture. Conditions can be performed using a non-reactive gas (e.g., N₂ and/or Ar) to, e.g., remove or substantially remove oxygen from the mixing environment. Suitable operating pressures can be utilized for conditions.

Additionally, a molar ratio of copper-amine to the phosphine can be adjusted as desired. In some examples, the molar ratio of the copper-amine to the phosphine is from about 1,000:1 to about 50:1, such as from about 800:1 to about 100:1, such as from about 600:1 to about 200:1, such as from about 500:1 to about 300:1, or from about 400:1 to about 100:1, such as from about 300:1 to about 200:1, based on the starting material molar ratio used for the reaction. Any of the foregoing numbers can be used singly to describe an open-ended range or in combination to describe a close-ended range.

In some aspects, and prior to making a mixture of the copper-amine and the phosphine, the phosphine can be mixed with an optional solvent. The solvent can include a nitrogen-containing compound (such as those described above), octadecene, benzyl ether, phenyl ether, or combinations thereof, though other suitable solvents are contemplated. The optional solvent and the phosphorous-containing compound can be heated under a non-reactive gas (e.g., N₂ and/or Ar) at a temperature of about 50° C. or more to about 400° C. or less, such as from about 100° C. to about 375° C., such as from about 150° C. to about 350° C., such as from about 200° C. to about 325° C., such as from about 250° C. to about 300° C., for a suitable time such as about 24 h or less, such as about 12 h or less, such as about 5 h or less, such as about 1 h or less, such as about 30 min or less, such as about 10 min or less and under suitable pressures. Any of the foregoing numbers can be used singly to describe an open-ended range or in combination to describe a close-ended range.

Operation 110 can include introduction conditions and reaction conditions. The introduction conditions of operation 110 refer to the conditions at which the nickel-amine is introduced to the mixture comprising the copper-amine, the phosphine, and optional solvent by, e.g., injection, addition, or otherwise combining. The reaction conditions of operation 110 refer to the conditions at which the resulting mixture comprising the nickel-amine, the copper-amine, the phosphine, and optional solvent are reacted. The introduction conditions and reaction conditions can be the same or different.

The introduction conditions of operation 110 includes an introduction temperature. The introduction temperature, or injection temperature, can be about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. Any of the foregoing numbers can be used singly to describe an open-ended range or in combination to describe a close-ended range. In some aspects, the introduction temperature or injection temperature of operation 110 can be from about 80° C. to about 320° C., such as from about 80° C. to about 150° C. or from about 180° C. to about 320° C., such as from about 200° C. to about 300° C., such as from about 225° C. to about 275° C., such as about 250° C. Any of the foregoing numbers can be used singly to describe an open-ended range or in combination to describe a close-ended range. Higher or lower introduction/injection temperatures can be used when appropriate.

The nickel-amine can then be added to the mixture comprising the copper-amine, the phosphine, and optional solvent. The introduction conditions of operation 110 can optionally include introducing N₂, Ar, and/or other non-reactive gases prior to, during, and/or after, introducing the nickel-amine to the mixture comprising the copper-amine, the phosphine, and the optional solvent.

A molar ratio of the nickel-amine to the copper-amine in the first mixture can be adjusted as desired. In some examples, the molar ratio of the nickel-amine to the copper-amine is from about 99:1 to about 1:1, such as from about 50:1 to about 1:1, such as from about 25:1 to about 1:1, such as from about 10:1 to about 1:1, such as from about 5:1 to about 1:1, or from about 50:1 to about 20:1, such as from about 40:1 to about 30:1, based on the starting material molar ratio used for the reaction. Any of the foregoing numbers can be used singly to describe an open-ended range or in combination to describe a close-ended range.

After introduction of the nickel-amine to the mixture comprising the copper-amine, the phosphine, and the optional solvent, one or more components of the resultant mixture react, under reaction conditions, to form a reaction product mixture comprising Ni—Cu nanoparticles. These Ni—Cu nanoparticles can be solid nanoparticles. The reaction conditions of operation 110 can include heating the mixture comprising the nickel-amine, the copper-amine, the phosphine, and the optional solvent at a reaction temperature of about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. Any of the foregoing numbers can be used singly to describe an open-ended range or in combination to describe a close-ended range. In some aspects, the reaction temperature of the reaction conditions of operation 110 can be from about 80° C. to about 320° C., such as from about 80° C. to about 150° C. or from about 180° C. to about 320° C., such as from about 200° C. to about 300° C., such as from about 225° C. to about 275° C., such as about 250° C. Any of the foregoing numbers can be used singly to describe an open-ended range or in combination to describe a close-ended range. Higher or lower temperatures can be used when appropriate. The reaction conditions of operation 110 can include a reaction time that is about 1 min or more or about 24 or less, such as from about 1 min to about 12 h, such as from about 5 min to about 3 h, such as from about 10 min to about 1 h. Higher or lower temperatures and/or more or less periods of time can be used when appropriate. Stirring, mixing, and/or agitation can be performed to, e.g., ensure homogeneity. The reaction conditions of operation 110 can include introducing N₂, Ar, and/or other non-reactive gases before, during, and/or after reaction of the one or more components.

In some examples, the reaction conditions of operation 110 include an operating temperature that is higher than, less than, or equal to the operating temperature of the introduction conditions of operation 110.

After a suitable time, the reaction product mixture comprising the Ni—Cu polyhedral nanoparticles formed during operation 110 can be subjected to filtration, separation, cleaning, quenching, washing, purification, and/or other suitable processes to remove undesired components and isolate the Ni—Cu polyhedral nanoparticles from the other components of the reaction product mixture. For example, the reaction product mixture comprising the Ni—Cu polyhedral nanoparticles can be centrifuged to separate the Ni—Cu polyhedral nanoparticles from the reaction product mixture. Additionally, or alternatively, the Ni—Cu polyhedral nanoparticles can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the Ni—Cu polyhedral nanoparticles from other components in the reaction product mixture. As an example, a solvent or mixture of solvents can be added to the Ni—Cu polyhedral nanoparticles and the resultant mixture centrifuged. The supernatant can be discarded and the remaining pellet can be dispersed in a suitable solvent or mixture of solvents. The resultant pellet and solvent(s) can then be centrifuged to obtain the Ni—Cu polyhedral nanoparticles.

As a non-limiting example of operation 110, an alkylphosphine with or without a nitrogen-containing compound, such as OLA, can be degassed using a non-reactive gas while agitating. The alkylphosphine with or without a nitrogen-containing compound can be heated to a temperature of about 275° C. to about 350° C. A copper-amine is then added to the alkylphosphine and agitated. The resultant mixture comprising the copper-amine and the alkylphosphine is then set to introduction conditions such as an introduction temperature (injection temperature) from about 100° C. to about 140° C., stirred for a suitable period of time, under suitable pressures, with or without the presence of a non-reactive gas. A nickel-amine is then added to the mixture at this introduction temperature (injection temperature) and stirred under the introduction conditions for a suitable period of time, under suitable pressures, with or without the presence of a non-reactive gas. At a selected time point, the mixture comprising the nickel-amine, the alkylphosphine, and the copper-amine are placed under the reaction conditions. The reaction conditions can be the same or different conditions as the introduction conditions. In this example, the reaction conditions include heating the mixture comprising the nickel-amine, the alkylphosphine, and the copper-amine, and optional nitrogen-containing compound(s) (as solvent(s)), at a temperature from about 225° C. to about 275° C. for a suitable period of time, under suitable pressures, and with or without the presence of a non-reactive gas, to form the reaction product mixture comprising the Ni—Cu polyhedral nanoparticles. The reaction product mixture comprising the Ni—Cu polyhedral nanoparticles can then be subjected to filtration, separation, cleaning, quenching, washing, purification, and/or other suitable processes to remove undesired components and/or isolate the Ni—Cu polyhedral nanoparticles from the other components of the reaction product mixture.

The Ni—Cu polyhedral nanoparticles formed by operation 110 can have any suitable mass percent (mass %) of Ni and Cu. The mass % of the Ni—Cu polyhedral nanoparticles is based on the total mass % of the Ni and the Cu, the total mass % not to exceed 100 mass %.

A mass % of Ni in the Ni—Cu polyhedral nanoparticles can be 1 mass % or more, 99 mass % or less, or combinations thereof, such as from about 10 mass % to about 95 mass %, such as from about 20 mass % to about 90 mass %, such as from about 30 mass % to about 85 mass %, such as from about 35 mass % to about 75 mass %, such as from about 40 mass % to about 70 mass %, such as from about 45 mass % to about 65 mass %, such as from about 50 mass % to about 60 mass %, though other values are contemplated. Any of the foregoing numbers can be used singly to describe an open-ended range or in combination to describe a close-ended range.

A mass % of Cu in the Ni—Cu polyhedral nanoparticles can be 1 mass % or more, 99 mass % or less, or combinations thereof, such as from about 5 mass % to about 90 mass %, such as from about 10 mass % to about 80 mass %, such as from about 20 mass % to about 70 mass %, such as from about 25 mass % to about 65 mass %, such as from about 30 mass % to about 60 mass %, such as from about 35 mass % to about 55 mass %, such as from about 40 mass % to about 50 mass %, though other values are contemplated. Any of the foregoing numbers can be used singly to describe an open-ended range or in combination to describe a close-ended range.

The Ni—Cu polyhedral nanoparticles can have a molar ratio of Ni:Cu that is from about 90:10 to about 10:90, such as from about 85:15 to about 15:85, such as from about 80:20 to about 20:80, such as from about 75:25 to about 25:75, such as from about 70:30 to about 30:70, such as from about 65:35 to about 35:65, such as from about 60:40 to about 40:60, such as from about 55:45 to about 45:55, or from about 70:30 to about 40:60, such as from about 60:40 to about 50:50, though other values are contemplated. Any of the foregoing numbers can be used singly to describe an open-ended range or in combination to describe a close-ended range.

The mass % of Ni, mass % of Cu, and molar ratio of Ni:Cu in the Ni—Cu polyhedral nanoparticles is based on analysis of the products formed from the reaction.

Process 100 can further include reacting a second mixture comprising the Ni—Cu polyhedral nanoparticles and a platinum-amine to form Pt—Ni—Cu polyhedral nanoparticles at operation 120. Operation 120 may also be referred to as a platinum ion treatment. While not wishing to be bound by any theory, it is believed that two chemical reactions may occur at this operation. First, platinum atoms can replace nickel atoms, copper atoms, or combinations thereof on the surface of the nanoparticles. Second, the platinum atoms can nucleate and grow on the surface of the Ni—Cu polyhedral nanostructure.

Platinum-amines useful for operation 120 include those described above with respect to the metal-amines. Operation 120 can include introducing the platinum-amine to the Ni—Cu polyhedral nanoparticles and an optional solvent. Here, and prior to making a mixture of the platinum-amine and the Ni—Cu polyhedral nanoparticles, the Ni—Cu polyhedral nanoparticles can be mixed with an optional solvent. The solvent can include a nitrogen-containing compound (such as those described above), octadecene, benzyl ether, phenyl ether, or combinations thereof, though other suitable solvents are contemplated. In these and other aspects, the platinum-amine can then be added to the Ni—Cu polyhedral nanoparticles and optional solvent. Operation 120 can include introduction conditions and reaction conditions. The introduction conditions of operation 120 refer to the conditions at which the platinum-amine is introduced to the Ni—Cu polyhedral nanoparticles and optional solvent by, e.g., injection, addition, or otherwise combining. The reaction conditions of operation 120 refer to the conditions at which the resulting mixture comprising the nickel-amine, the platinum-amine, the Ni—Cu polyhedral nanoparticles, and optional solvent are reacted. The introduction conditions and reaction conditions can be the same or different.

The introduction conditions of operation 120 includes an introduction temperature. The introduction temperature, or injection temperature, can be about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. Any of the foregoing numbers can be used singly to describe an open-ended range or in combination to describe a close-ended range. In some aspects, the introduction temperature or injection temperature of operation 120 can be from about 80° C. to about 320° C., such as from about 80° C. to about 150° C. or from about 180° C. to about 320° C., such as from about 200° C. to about 300° C., such as from about 225° C. to about 275° C., such as about 250° C. Any of the foregoing numbers can be used singly to describe an open-ended range or in combination to describe a close-ended range. Higher or lower introduction/injection temperatures can be used when appropriate.

The platinum-amine can then be added to the Ni—Cu polyhedral nanoparticles and optional solvent. The introduction conditions of operation 120 can optionally include introducing N₂, Ar, and/or other non-reactive gases prior to, during, and/or after, introducing the platinum-amine to the mixture comprising the Ni—Cu polyhedral nanoparticles and optional solvent.

A molar ratio of the Ni—Cu polyhedral nanoparticles to the platinum-amine in the second mixture can be adjusted as desired. In some examples, the molar ratio of the Ni—Cu polyhedral nanoparticles to the platinum-amine is from about 500:1 to about 1:50, such as from about 400:1 to about 1:25, such as from about 250:1 to about 1:10, such as from about 100:1 to about 1:5, such as from about 50:1 to about 1:1, or from about 100:1 to about 20:1, such as from about 80:1 to about 40:1, such as from about 70:1 to about 50:1, based on the starting material molar ratio used for the reaction. Any of the foregoing numbers can be used singly to describe an open-ended range or in combination to describe a close-ended range.

After introduction of the platinum-amine to the Ni—Cu polyhedral nanoparticles and optional solvent, one or more components of the resultant mixture react, under reaction conditions, to form a reaction product mixture comprising Pt—Ni—Cu polyhedral nanoparticles. These Pt—Ni—Cu nanoparticles can be solid nanoparticles. The reaction conditions of operation 120 can include heating the mixture comprising the platinum-amine, the Ni—Cu polyhedral nanoparticles, and the optional solvent at a reaction temperature of about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. Any of the foregoing numbers can be used singly to describe an open-ended range or in combination to describe a close-ended range. In some aspects, the reaction temperature of the reaction conditions of operation 120 can be from about 80° C. to about 320° C., such as from about 80° C. to about 150° C. or from about 180° C. to about 320° C., such as from about 200° C. to about 300° C., such as from about 225° C. to about 275° C., such as about 250° C. Any of the foregoing numbers can be used singly to describe an open-ended range or in combination to describe a close-ended range. Higher or lower temperatures can be used when appropriate. The reaction conditions of operation 120 can include reacting the mixture comprising the platinum-amine, the Ni—Cu polyhedral nanoparticles, and the optional solvent for a reaction time that is about 1 min or more or about 24 or less, such as from about 1 min to about 12 h, such as from about 5 min to about 3 h, such as from about 10 min to about 1 h. Higher or lower temperatures and/or more or less periods of time can be used when appropriate. Stirring, mixing, and/or agitation can be performed to, e.g., ensure homogeneity. The reaction conditions of operation 120 can include introducing N₂, Ar, and/or other non-reactive gases before, during, and/or after reaction of the one or more components.

In some examples, the reaction conditions of operation 120 include an operating temperature that is higher than, less than, or equal to the operating temperature of the introduction conditions of operation 120.

After a suitable time, the reaction product mixture comprising the Pt—Ni—Cu polyhedral nanoparticles formed during operation 120 can be subjected to filtration, separation, cleaning, quenching, washing, purification, and/or other suitable processes to remove undesired components and isolate the Pt—Ni—Cu polyhedral nanoparticles from the other components of the reaction product mixture. For example, the reaction product mixture comprising the Pt—Ni—Cu polyhedral nanoparticles can be centrifuged to separate the Pt—Ni—Cu polyhedral nanoparticles from the reaction product mixture. Additionally, or alternatively, the Pt—Ni—Cu polyhedral nanoparticles can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the Pt—Ni—Cu polyhedral nanoparticles from other components in the reaction product mixture. As an example, a solvent or mixture of solvents can be added to the Pt—Ni—Cu polyhedral nanoparticles and the resultant mixture centrifuged. The supernatant can be discarded and the remaining pellet can be dispersed in a suitable solvent or mixture of solvents. The resultant pellet and solvent(s) can then be centrifuged to obtain the Pt—Ni—Cu polyhedral nanoparticles.

As a non-limiting example of operation 120, a mixture of Ni—Cu polyhedral nanoparticles and a solvent (for example, OLA and/or octadecene) can be degassed using a non-reactive gas while agitating. The mixture of Ni—Cu polyhedral nanoparticles and solvent is then set to introduction conditions, such as an introduction temperature (injection temperature) from about 70° C. to about 100° C., stirred for a suitable period of time, under suitable pressures, with or without the presence of a non-reactive gas. A platinum-amine is then added to the mixture at this introduction temperature (injection temperature) and stirred under the introduction conditions for a suitable period of time, under suitable pressures, with or without the presence of a non-reactive gas. At a selected time point, the mixture comprising the platinum-amine, Ni—Cu polyhedral nanoparticles, and solvent are placed under the reaction conditions. The reaction conditions can be the same or different conditions as the introduction conditions. In this example, the reaction conditions include heating the mixture comprising the platinum-amine, Ni—Cu polyhedral nanoparticles, and solvent at a temperature from about 180° C. to about 220° C. for a suitable period of time, under suitable pressures, and with or without the presence of a non-reactive gas, to form the reaction product mixture comprising the Pt—Ni—Cu polyhedral nanoparticles. The reaction product mixture comprising the Pt—Ni—Cu polyhedral nanoparticles can then be subjected to filtration, separation, cleaning, quenching, washing, purification, and/or other suitable processes to remove undesired components and/or isolate the Pt—Ni—Cu polyhedral nanoparticles from the other components of the reaction product mixture.

The Pt—Ni—Cu polyhedral nanoparticles formed by operation 120 can have any suitable mass % of Pt, Ni, and Cu. The mass % of the Pt—Ni—Cu polyhedral nanoparticles is based on the total mass % of the Pt, the Ni, and the Cu, the total mass % not to exceed 100 mass %.

A mass % of Pt in the Pt—Ni—Cu polyhedral nanoparticles can be greater than 0 mass %, 45 mass % or less, or combinations thereof, such as from greater than 0 mass % to about 45 mass %, such as from about 1 mass % to about 40 mass %, such as from about 5 mass % to about 35 mass %, such as from about 10 mass % to about 30 mass %, such as from about 15 mass % to about 25 mass %, or from about 20 mass % to about 40 mass %, such as from about 25 mass % to about 35 mass %, though other values are contemplated. Any of the foregoing numbers can be used singly to describe an open-ended range or in combination to describe a close-ended range.

A mass % of Ni in the Pt—Ni—Cu polyhedral nanoparticles can be 10 mass % or more, 90 mass % or less, or combinations thereof, such as from about 10 mass % to about 90 mass %, such as from about 15 mass % to about 75 mass %, such as from about 20 mass % to about 60 mass %, such as from about 25 mass % to about 55 mass %, such as from about 30 mass % to about 60 mass %, such as from about 35 mass % to about 55 mass %, such as from about 40 mass % to about 50 mass %, though other values are contemplated. Any of the foregoing numbers can be used singly to describe an open-ended range or in combination to describe a close-ended range.

A mass % of Cu in the Pt—Ni—Cu polyhedral nanoparticles can be 5 mass % or more, 90 mass % or less, or combinations thereof, such as from about 5 mass % to about 60 mass %, such as from about 10 mass % to about 40 mass %, such as from about 15 mass % to about 35 mass %, such as from about 20 mass % to about 30 mass %, though other values are contemplated. Any of the foregoing numbers can be used singly to describe an open-ended range or in combination to describe a close-ended range.

A molar ratio of Ni to Pt (Ni:Pt) in the Pt—Ni—Cu polyhedral nanoparticles can be from about 0.3:1 to about 6:1, such as from about 0.5:1 to about 3:1, such as from about 1:1 to about 2.5:1, such as from about 1.5:1 to about 2:1, such as about 2:1, though other values are contemplated. Any of the foregoing numbers can be used singly to describe an open-ended range or in combination to describe a close-ended range.

A molar ratio of Cu to Pt (Ni:Pt) in the Pt—Ni—Cu polyhedral nanoparticles can be from about 0.1:1 to about 3:1, such as from about 0.25:1 to about 2.75:1, such as from about 0.5:1 to about 2:1, such as from about 1:1 to about 1.5:1, though other values are contemplated. Any of the foregoing numbers can be used singly to describe an open-ended range or in combination to describe a close-ended range.

The Pt—Ni—Cu polyhedral nanoparticles can have a molar ratio of Ni to Cu to Pt (Ni:Cu:Pt) that is from about 0.3:0.1:1 to about 6:3:1, such as from about 0.5:0.5:1 to about 2:2:1, though other values are contemplated.

The mass % of Ni, mass % of Cu, mass % of Pt, and molar ratio of Ni:Cu:Pt in the Pt—Ni—Cu polyhedral nanoparticles is based on analysis of the products formed from the reaction.

Process 100 can further include reacting a third mixture comprising the Pt—Ni—Cu polyhedral nanoparticles and a Group 8-11 metal-amine to form Pt—Ni—Cu-M polyhedral nanoparticles at operation 130. M is a Group 8-11 metal in Pt—Ni—Cu-M polyhedral nanoparticles, and M is different from Pt, Ni, and Cu. Operation 130 may be referred to as a metal ion treatment. While not wishing to be bound by any theory, it is believed that residual (not alloyed) Cu and Ni atoms on the Pt—Ni—Cu surface can be replaced by the Group 8-11 metal (M) during operation 130.

Group 8-11 metal-amines useful for operation 130 include those described above with respect to the metal amines. The Group 8-11 metal-amine includes a Group 8-11 metal (M) of the periodic table of the elements that is different from Pt, Ni, and Cu. In some aspects, the Group 8-11 metal (M) of the Group 8-11 metal-amine comprises Fe, Ru, Os, Co, Rh, Ir, Pd, Ag, or Au, such as Au, Ag, Pd, Co, or Fe.

Operation 130 can include introducing the Group 8-11 metal-amine to the Pt—Ni—Cu polyhedral nanoparticles and an optional solvent. Here, and prior to making a mixture of the Group 8-11 metal-amine and the Pt—Ni—Cu polyhedral nanoparticles, the Pt—Ni—Cu polyhedral nanoparticles can be mixed with an optional solvent. The solvent can include a nitrogen-containing compound (such as those described above), octadecene, benzyl ether, phenyl ether, or combinations thereof, though other suitable solvents are contemplated. In these and other aspects, the Group 8-11 metal-amine can then be added to the Pt—Ni—Cu polyhedral nanoparticles and optional solvent. Operation 130 can include introduction conditions and reaction conditions. The introduction conditions of operation 130 refer to the conditions at which the Group 8-11 metal-amine is introduced to the Pt—Ni—Cu polyhedral nanoparticles and optional solvent by, e.g., injection, addition, or otherwise combining. The reaction conditions of operation 130 refer to the conditions at which the resulting mixture comprising the Group 8-11 metal-amine, the Pt—Ni—Cu polyhedral nanoparticles, and optional solvent are reacted. The introduction conditions and reaction conditions can be the same or different.

The introduction conditions of operation 130 includes an introduction temperature. The introduction temperature, or injection temperature, of operation 130 can be about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. Any of the foregoing numbers can be used singly to describe an open-ended range or in combination to describe a close-ended range. In some aspects, the introduction temperature or injection temperature of operation 130 can be from about 80° C. to about 320° C., such as from about 80° C. to about 150° C. or from about 180° C. to about 320° C., such as from about 200° C. to about 300° C., such as from about 225° C. to about 275° C., such as about 250° C. Any of the foregoing numbers can be used singly to describe an open-ended range or in combination to describe a close-ended range. Higher or lower introduction/injection temperatures can be used when appropriate.

The Group 8-11 metal-amine can then be added to the Pt—Ni—Cu polyhedral nanoparticles and the optional solvent. The introduction conditions of operation 130 can optionally include introducing N₂, Ar, and/or other non-reactive gases prior to, during, and/or after, introducing the Group 8-11 metal-amine to the mixture comprising the Pt—Ni—Cu polyhedral nanoparticles and the optional solvent.

A molar ratio of the Pt—Ni—Cu polyhedral nanoparticles to the Group 8-11 metal-amine in the third mixture can be adjusted as desired. In some examples, the molar ratio of the Pt—Ni—Cu polyhedral nanoparticles to the Group 8-11 metal-amine is from about 500:1 to about 1:10, such as from about 400:1 to about 1:5, such as from about 300:1 to about 1:1, such as from about 200:1 to about 10:1, such as from about 100:1 to about 20:1, such as from about 50:1 to about 25:1, or from about 50:1 to about 20:1, such as from about 40:1 to about 30:1, based on the starting material molar ratio used for the reaction. Any of the foregoing numbers can be used singly to describe an open-ended range or in combination to describe a close-ended range.

After introduction of the Group 8-11 metal-amine to the Pt—Ni—Cu polyhedral nanoparticles and optional solvent, one or more components of the resultant mixture react, under reaction conditions, to form a reaction product mixture comprising Pt—Ni—Cu-M polyhedral nanoparticles wherein M is the Group 8-11 metal that is different from Pt, Ni, and Cu. These Pt—Ni—Cu-M nanoparticles can be solid nanoparticles. The reaction conditions of operation 130 can include heating the mixture comprising the Group 8-11 metal-amine, the Pt—Ni—Cu polyhedral nanoparticles, and the optional solvent at a reaction temperature of about 400° C. or less, such as from about 50° C. to about 400° C., such as from about 75° C. to about 375° C., such as from about 80° C. to about 340° C., such as from about 90° C. to about 330° C., such as from about 100° C. to about 320° C., such as from about 110° C. to about 310° C., such as from about 120° C. to about 300° C., such as from about 130° C. to about 290° C., such as from about 140° C. to about 280° C., such as from about 150° C. to about 270° C., such as from about 160° C. to about 260° C., such as from about 170° C. to about 250° C., such as from about 180° C. to about 240° C., such as from about 190° C. to about 230° C., such as from about 200° C. to about 220° C. Any of the foregoing numbers can be used singly to describe an open-ended range or in combination to describe a close-ended range. In some aspects, the reaction temperature of the reaction conditions of operation 130 can be from about 80° C. to about 320° C., such as from about 80° C. to about 150° C. or from about 180° C. to about 320° C., such as from about 200° C. to about 300° C., such as from about 225° C. to about 275° C., such as about 250° C. Any of the foregoing numbers can be used singly to describe an open-ended range or in combination to describe a close-ended range. Higher or lower temperatures can be used when appropriate. The reaction conditions of operation 130 can include reacting the mixture comprising the Group 8-11 metal-amine, the Pt—Ni—Cu polyhedral nanoparticles, and the optional solvent for a reaction time that is about 1 min or more or about 24 or less, such as from about 1 min to about 12 h, such as from about 5 min to about 3 h, such as from about 10 min to about 1 h. Higher or lower temperatures and/or more or less periods of time can be used when appropriate. Stirring, mixing, and/or agitation can be performed to, e.g., ensure homogeneity. The reaction conditions of operation 130 can include introducing N₂, Ar, and/or other non-reactive gases before, during, and/or after reaction of the one or more components.

In some examples, the reaction conditions of operation 130 include an operating temperature that is higher than, less than, or equal to the operating temperature of the introduction conditions of operation 130.

After a suitable time, the reaction product mixture comprising the Pt—Ni—Cu-M polyhedral nanoparticles formed during operation 130 can be subjected to filtration, separation, cleaning, quenching, washing, purification, and/or other suitable processes to remove undesired components and isolate the Pt—Ni—Cu-M polyhedral nanoparticles from the other components of the reaction product mixture. For example, the reaction product mixture comprising the Pt—Ni—Cu-M polyhedral nanoparticles can be centrifuged to separate the Pt—Ni—Cu-M polyhedral nanoparticles from the reaction product mixture. Additionally, or alternatively, the Pt—Ni—Cu-M polyhedral nanoparticles can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the Pt—Ni—Cu-M polyhedral nanoparticles from other components in the reaction product mixture. As an example, a solvent or mixture of solvents can be added to the Pt—Ni—Cu-M polyhedral nanoparticles and the resultant mixture centrifuged. The supernatant can be discarded and the remaining pellet can be dispersed in a suitable solvent or mixture of solvents. The resultant pellet and solvent(s) can then be centrifuged to obtain the Pt—Ni—Cu-M polyhedral nanoparticles.

As a non-limiting example of operation 130, a mixture of Pt—Ni—Cu polyhedral nanoparticles and a solvent (for example, OLA and/or octadecene) can be degassed using a non-reactive gas while agitating. The mixture of Pt—Ni—Cu polyhedral nanoparticles and solvent is then set to introduction conditions, such as an introduction temperature (injection temperature) from about 70° C. to about 100° C., stirred for a suitable period of time, under suitable pressures, with or without the presence of a non-reactive gas. A Group 8-11 metal-amine (such as a gold-amine, a palladium-amine, a silver-amine, a cobalt-amine, an iron-amine, etc.) is then added to the mixture at this introduction temperature (injection temperature) and stirred under the introduction conditions for a suitable period of time, under suitable pressures, with or without the presence of a non-reactive gas. At a selected time point, the mixture comprising the Group 8-11 metal-amine, Pt—Ni—Cu polyhedral nanoparticles, and solvent are placed under the reaction conditions. The reaction conditions can be the same or different conditions as the introduction conditions. In this example, the reaction conditions include heating the mixture comprising the Group 8-11 metal-amine, Pt—Ni—Cu polyhedral nanoparticles, and solvent at a temperature from about 180° C. to about 220° C. for a suitable period of time, under suitable pressures, and with or without the presence of a non-reactive gas, to form the reaction product mixture comprising the Pt—Ni—Cu-M polyhedral nanoparticles. The reaction product mixture comprising the Pt—Ni—Cu-M polyhedral nanoparticles can then be subjected to filtration, separation, cleaning, quenching, washing, purification, and/or other suitable processes to remove undesired components and/or isolate the Pt—Ni—Cu-M polyhedral nanoparticles from the other components of the reaction product mixture.

The Pt—Ni—Cu-M polyhedral nanoparticles formed by operation 130 can have any suitable mass % of Pt, Ni, Cu, and M. The mass % of the Pt—Ni—Cu-M polyhedral nanoparticles is based on the total mass % of the Pt, the Ni, and the Cu, the total mass % not to exceed 100 mass %.

A mass % of Pt in the Pt—Ni—Cu-M polyhedral nanoparticles can be greater than 0 mass %, 45 mass % or less, or combinations thereof, such as from greater than 0 mass % to about 45 mass %, such as from about 1 mass % to about 40 mass %, such as from about 5 mass % to about 35 mass %, such as from about 10 mass % to about 30 mass %, such as from about 15 mass % to about 25 mass %, or from about 20 mass % to about 40 mass %, such as from about 25 mass % to about 35 mass %, or from about 20 mass % to about 30 mass %, though other values are contemplated. Any of the foregoing numbers can be used singly to describe an open-ended range or in combination to describe a close-ended range.

A mass % of Ni in the Pt—Ni—Cu-M polyhedral nanoparticles can be 5 mass % or more, 50 mass % or less, or combinations thereof, such as from about 10 mass % to about 45 mass %, such as from about 15 mass % to about 40 mass %, such as from about 20 mass % to about 35 mass %, such as from about 25 mass % to about 30 mass %, or from about 15 mass % to about 35 mass %, such as from about 20 mass % to about 30 mass %, such as from about 20 mass % to about 25 mass %, though other values are contemplated. Any of the foregoing numbers can be used singly to describe an open-ended range or in combination to describe a close-ended range.

A mass % of Cu in the Pt—Ni—Cu-M polyhedral nanoparticles can be 5 mass % or more, 50 mass % or less, or combinations thereof, such as from about 10 mass % to about 40 mass %, such as from about 15 mass % to about 35 mass %, such as from about 20 mass % to about 30 mass %, such as from about 20 mass % to about 25 mass % or from about 25 mass % to about 30 mass %, though other values are contemplated. Any of the foregoing numbers can be used singly to describe an open-ended range or in combination to describe a close-ended range.

A mass % of the Group 8-11 metal (M) that is different from Pt, Ni, and Cu in the Pt—Ni—Cu-M polyhedral nanoparticles can be greater than 0 mass %, less than about 20 mass %, or combinations thereof, such as from greater than 0 mass % to about 20 mass %, such as from about 1 mass % to about 15 mass %, such as from about 3 mass % to about 13 mass %, such as from about 5 mass % to about 10 mass %, though other values are contemplated. Any of the foregoing numbers can be used singly to describe an open-ended range or in combination to describe a close-ended range.

A molar ratio of Ni to Pt (Ni:Pt) in the Pt—Ni—Cu-M polyhedral nanoparticles can be from about 0.5:1 to about 3:1, such as from about 0.75:1 to about 2.5:1, such as from about 1:1 to about 2:1, such as from about 1.25:1 to about 1.75:1, such as about 1.5:1, or from about 0.7:1 to about 1:1, such as from about 0.8:1 to about 0.9:1, though other values are contemplated. Any of the foregoing numbers can be used singly to describe an open-ended range or in combination to describe a close-ended range.

A molar ratio of Cu to Pt (Ni:Pt) in the Pt—Ni—Cu-M polyhedral nanoparticles can be from about 0.5:1 to about 2:1, such as from about 0.75:1 to about 1.75:1, such as from about 1:1 to about 1.5:1, such as about 1.25:1, or from about 0.7:1 to about 1:1, such as from about 0.8:1 to about 0.9:1, though other values are contemplated. Any of the foregoing numbers can be used singly to describe an open-ended range or in combination to describe a close-ended range.

A molar ratio of M to Pt (M:Pt) in in the Pt—Ni—Cu-M polyhedral nanoparticles can be from about 0.1:1 to about 0.5:1, such as from about 0.2:1 to about 0.4:1, such as from about 0.25:1 to about 1.35:1, such as about 0.3:1, or from about 0.2:1 to about 0.3:1, such as about 0.25:1, though other values are contemplated. Any of the foregoing numbers can be used singly to describe an open-ended range or in combination to describe a close-ended range.

The Pt—Ni—Cu-M polyhedral nanoparticles can have a molar ratio of Ni to Cu to Pt to M (Ni:Cu:Pt:M) that is from about 0.5:0.5:1:0.1 to about 3:2:1:0.5, such as from about 0.7:0.7:1:0.2 to about 1:1:1:0.3, though other values are contemplated.

The mass % of Ni, mass % of Cu, mass % of Pt, mass % of Group 8-11 metal (M), and molar ratio of Ni:Cu:Pt:M in the Pt—Ni—Cu-M polyhedral nanoparticles is based on analysis of the products formed from the reaction.

Process 100 can further include reacting a fourth mixture comprising the Pt—Ni—Cu-M polyhedral nanoparticles and an acid to form multimetallic nanostructures. The multimetallic nanostructures can be at least partially hollow. The multimetallic nanostructures can include four different metals. The multimetallic nanostructures can include Pt—Ni—Cu-M polyhedral nanoparticles that are at least partially hollow. While not wishing to be bound by any theory, it is believed that residual (not alloyed) Pt, Ni, Cu, or Group 8-11 metal (M) atoms on the Pt—Ni—Cu-M surface can be dissolved by treatment with the acid, resulting in Pt—Ni—Cu-M polyhedral nanoparticles that are at least partially hollow. The partially hollow or hollow Pt—Ni—Cu-M polyhedral nanoparticles are characterized as having voids. The partially hollow or hollow Pt—Ni—Cu-M polyhedral nanoparticles can be referred to as nanoframes.

Acids useful for operation 140 can be any suitable inorganic acid, organic acid, or combinations thereof. Illustrative, but non-limiting, examples of acids useful for operation 140 can include acetic acid (CH₃COOH), carbonic acid (H₂CO₃), propionic acid (CH₃CH₂CO₂H), phosphoric acid (H₃PO₄), sulfuric acid (H₂SO₄), nitric acid (HNO₃), perchloric acid (HClO₄), hydrochloric acid (HCl), or combinations thereof, such as acetic acid, phosphoric acid, carbonic acid, sulfuric acid, perchloric acid, or combinations thereof. The acid may be provided as a solution, for example, an aqueous solution or organic solution. In some aspects, the concentration of acid in the solution is from about 0.01 M to about 10 M, such as from about 0.1 M to about 2 M, such as from about 0.5 M to about 1.5 M, such as from about 1 M to about 1.25 M. Any of the foregoing numbers can be used singly to describe an open-ended range or in combination to describe a close-ended range.

Operation 140 can include introducing the acid to the Pt—Ni—Cu-M polyhedral nanoparticles. Here, and prior to making a mixture of the acid and the Pt—Ni—Cu-M polyhedral nanoparticles, the Pt—Ni—Cu-M polyhedral nanoparticles can be mixed with an optional solvent. The solvent can include, for example, an aqueous solvent, an alcohol solvent, a ketone solvent, or combinations thereof, such as water, ethanol, methanol, acetone, or combinations thereof, though other suitable solvents are contemplated. In these and other aspects, the acid can then be added to the Pt—Ni—Cu-M polyhedral nanoparticles and optional solvent.

Operation 140 can include introduction conditions and reaction conditions. The introduction conditions of operation 140 refer to the conditions at which the acid is introduced to the Pt—Ni—Cu-M polyhedral nanoparticles and optional solvent by, e.g., injection, addition, or otherwise combining. The reaction conditions of operation 140 refer to the conditions at which the resulting mixture comprising the acid, the Pt—Ni—Cu-M polyhedral nanoparticles, and optional solvent are reacted. The introduction conditions and reaction conditions can be the same or different.

The introduction conditions of operation 140 includes an introduction temperature. The introduction temperature, or injection temperature, of operation 140 can be about 10° C. or more, 100° C. or less, or combinations thereof, such as from about 15° C. to about 95° C., such as from about 20° C. to about 90° C., such as from about 30° C. to about 80° C., such as from about 40° C. to about 70° C., such as from about 50° C. to about 60° C., or from about 15° C. to about 30° C., such as from about 15° C. to about 20° C. or from about 20° C. to about 25° C. Any of the foregoing numbers can be used singly to describe an open-ended range or in combination to describe a close-ended range. Higher or lower introduction/injection temperatures can be used when appropriate.

The acid can then be added to the Pt—Ni—Cu-M polyhedral nanoparticles and optional solvent. The introduction conditions of operation 140 can optionally include introducing N₂, Ar, and/or other non-reactive gases prior to, during, and/or after, introducing the acid to the mixture comprising the Pt—Ni—Cu-M polyhedral nanoparticles and the optional solvent.

A molar ratio of the Pt—Ni—Cu-M polyhedral nanoparticles to the acid in the fourth mixture can be adjusted as desired. In some examples, the molar ratio of the Pt—Ni—Cu-M polyhedral nanoparticles to the acid is from about 100:1 to about 1:100, such as from about 50:1 to about 1:50, such as from about 20:1 to about 1:20, such as from about 10:1 to about 1:10, such as from about 5:1 to about 1:5, such as from about 3:1 to about 1:3, such as about 1:1, or from about 10:1 to about 1:50, such as from about 5:1 to about 1:20, based on the starting material molar ratio used for the reaction. Any of the foregoing numbers can be used singly to describe an open-ended range or in combination to describe a close-ended range.

After introduction of the acid to the Pt—Ni—Cu-M polyhedral nanoparticles and optional solvent, one or more components of the resultant mixture react, under reaction conditions, to form a reaction product mixture comprising multimetallic nanostructures that are at least partially hollow. The at least partially hollow multimetallic nanostructures can include at least partially hollow (or hollow) Pt—Ni—Cu-M polyhedral nanoparticles.

The reaction conditions of operation 140 can include reacting the mixture comprising the acid, Pt—Ni—Cu-M polyhedral nanoparticles, and optional solvent at a reaction temperature that is about 10° C. or more, 100° C. or less, or combinations thereof, such as from about 15° C. to about 95° C., such as from about 20° C. to about 90° C., such as from about 30° C. to about 80° C., such as from about 40° C. to about 70° C., such as from about 50° C. to about 60° C., or from about 15° C. to about 30° C., such as from about 15° C. to about 20° C. or from about 20° C. to about 25° C. Any of the foregoing numbers can be used singly to describe an open-ended range or in combination to describe a close-ended range. Higher or lower reaction temperatures can be used when appropriate. The reaction conditions of operation 140 can include reacting the mixture comprising the acid, the Pt—Ni—Cu-M polyhedral nanoparticles, and the optional solvent for a reaction time that is about 1 min or more, about 7 days or less, or combinations thereof, such as from about 1 min to about 7 days, such as from about 1 hour to about 6 days, such as from about 5 hours to about 5 days, such as from about 10 hours to about 60 hours, such as from about 20 hours to about 48 hours, though other reaction periods are contemplated. Stirring, mixing, and/or agitation can be performed to, e.g., ensure homogeneity. The reaction conditions of operation 140 can include introducing N₂, Ar, and/or other non-reactive gases before, during, and/or after reaction of the one or more components.

In some examples, the reaction conditions of operation 140 include an operating temperature that is higher than, less than, or equal to the operating temperature of the introduction conditions of operation 140.

After a suitable time, the reaction product mixture comprising the at least partially hollow Pt—Ni—Cu-M polyhedral nanoparticles formed during operation 140 can be subjected to filtration, separation, cleaning, quenching, washing, purification, and/or other suitable processes to remove undesired components and isolate the at least partially hollow Pt—Ni—Cu-M polyhedral nanoparticles from the other components of the reaction product mixture. For example, the reaction product mixture comprising the at least partially hollow Pt—Ni—Cu-M polyhedral nanoparticles can be centrifuged to separate the at least partially hollow Pt—Ni—Cu-M polyhedral nanoparticles from the reaction product mixture. Additionally, or alternatively, the at least partially hollow Pt—Ni—Cu-M polyhedral nanoparticles can be washed with polar solvent(s), such as water, acetone, ethanol, methanol, or combinations thereof, and/or non-polar solvent(s), such as hexane, pentane, toluene, or combinations thereof. Other solvents for washing can include ether solvents such as diethyl ether and tetrahydrofuran; chlorocarbon solvents such as dichloromethane and chloroform; as well as ethyl acetate, dimethylformamide, acetonitrile, benzene, isopropanol, n-butanol, n-propanol. Mixtures of two or more of these solvents, in suitable proportions, can be utilized for washing, purifying, or otherwise separating the at least partially hollow Pt—Ni—Cu-M polyhedral nanoparticles from other components in the reaction product mixture. As an example, a solvent or mixture of solvents can be added to the at least partially hollow Pt—Ni—Cu-M polyhedral nanoparticles and the resultant mixture centrifuged. The supernatant can be discarded and the remaining pellet can be dispersed in a suitable solvent or mixture of solvents. The resultant pellet and solvent(s) can then be centrifuged to obtain the at least partially hollow Pt—Ni—Cu-M polyhedral nanoparticles (nanoframes).

As a non-limiting example of operation 140, a mixture of Pt—Ni—Cu-M polyhedral nanoparticles and a solvent (for example, water) can be degassed using a non-reactive gas while agitating. The mixture of Pt—Ni—Cu-M polyhedral nanoparticles and solvent is then set to introduction conditions, such as an introduction temperature (injection temperature) from about 15° C. to about 25° C., stirred for a suitable period of time, under suitable pressures, with or without the presence of a non-reactive gas. Acid (such as acetic acid) is then added to the mixture at this introduction temperature (injection temperature) and stirred under the introduction conditions for a suitable period of time, under suitable pressures, with or without the presence of a non-reactive gas. At a selected time point, the mixture comprising the acid, Pt—Ni—Cu-M polyhedral nanoparticles, and solvent are placed under the reaction conditions. The reaction conditions can be the same or different conditions as the introduction conditions. In this example, the reaction conditions include reacting the mixture at a temperature from about 15° C. to about 25° C. for a suitable period of time (about 36 hours to 60 hours), under suitable pressures, and with or without the presence of a non-reactive gas, to form the reaction product mixture comprising the at least partially hollow Pt—Ni—Cu-M polyhedral nanoparticles. The reaction product mixture comprising the at least partially hollow Pt—Ni—Cu-M polyhedral nanoparticles can then be subjected to filtration, separation, cleaning, quenching, washing, purification, and/or other suitable processes to remove undesired components and/or isolate the at least partially hollow Pt—Ni—Cu-M polyhedral nanoparticles (nanoframes) from the other components of the reaction product mixture.

The acid treatment of operation 140 can cause the at least partially hollow Pt—Ni—Cu-M polyhedral nanoparticles (nanoframes) products to have a higher mass % of a metal element relative to the Pt—Ni—Cu-M polyhedral nanoparticles used as starting material before acid treatment. For example, a first mass % of the Group 8-11 metal (M) in the Pt—Ni—Cu-M polyhedral nanoparticles (starting material) can be less than a second mass % of the Group 8-11 metal (M) in the at least partially hollow Pt—Ni—Cu-M polyhedral nanoparticles product (nanoframes).

In some examples, the acid treatment of operation 140 can result in one or more of the following:
(a) products (nanoframes) having a higher mass % of Pt than the mass % of Pt in the Pt—Ni—Cu-M polyhedral nanoparticles used as starting material;
(b) products (nanoframes) having a lower mass % of Ni than the mass % of Ni in the Pt—Ni—Cu-M polyhedral nanoparticles used as starting material;
(c) products (nanoframes) having a lower mass % of Cu than the mass % of Cu in the Pt—Ni—Cu-M polyhedral nanoparticles used as starting material; and/or
(d) products (nanoframes) having a higher mass % of the Group 8-11 metal (M) than the mass % of the Group 8-11 metal (M) in the Pt—Ni—Cu-M polyhedral nanoparticles used as starting material.

The at least partially hollow Pt—Ni—Cu-M polyhedral nanoparticles (nanoframes) formed by operation 140 can have any suitable mass % of Pt, Ni, Cu, and M. The mass % of the at least partially hollow Pt—Ni—Cu-M polyhedral nanoparticles is based on the total mass % of the Pt, the Ni, and the Cu, the total mass % not to exceed 100 mass %.

A mass % of Pt in the at least partially hollow Pt—Ni—Cu-M polyhedral nanoparticles (nanoframes) can be about 10 mass % or more, about 40 mass % or less, or combinations thereof, such as from about 10 mass % to about 40 mass %, such as from about 15 mass % to about 35 mass %, such as from about 20 mass % to about 30, such as from about 20 mass % to about 25 mass % or from about 25 mass % to about 30 mass %, though other values are contemplated. Any of the foregoing numbers can be used singly to describe an open-ended range or in combination to describe a close-ended range.

A mass % of Ni in the at least partially hollow Pt—Ni—Cu-M polyhedral nanoparticles (nanoframes) can be about 10 mass % or more, about 40 mass % or less, or combinations thereof, such as from about 10 mass % to about 40 mass %, such as from about 15 mass % to about 35 mass %, such as from about 20 mass % to about 30, such as from about 20 mass % to about 25 mass % or from about 25 mass % to about 30 mass %, though other values are contemplated. Any of the foregoing numbers can be used singly to describe an open-ended range or in combination to describe a close-ended range.

A mass % of Cu in the at least partially hollow Pt—Ni—Cu-M polyhedral nanoparticles (nanoframes) can be 5 mass % or more, 30 mass % or less, or combinations thereof, such as from about 5 mass % to about 30 mass %, such as from about 10 mass % to about 25 mass %, such as from about 15 mass % to about 20 mass % or from about 10 mass % to about 20 mass %, though other values are contemplated. Any of the foregoing numbers can be used singly to describe an open-ended range or in combination to describe a close-ended range.

A mass % of the Group 8-11 metal (M) that is different from Pt, Ni, and Cu in the at least partially hollow Pt—Ni—Cu-M polyhedral nanoparticles (nanoframes) can be greater than 0 mass %, less than about 25 mass %, or combinations thereof, such as from greater than 0 mass % to about 25 mass %, such as from about 5 mass % to about 20 mass %, such as from about 5 mass % to about 15 mass %, or from about 10 mass % to about 20 mass %, or from about 10 mass % to about 15 mass %, though other values are contemplated. Any of the foregoing numbers can be used singly to describe an open-ended range or in combination to describe a close-ended range.

A molar ratio of Ni to Pt (Ni:Pt) in the at least partially hollow Pt—Ni—Cu-M polyhedral nanoparticles (nanoframes) can be from about 0.5:1 to about 2:1, such as from about 0.75:1 to about 1.75:1, such as from about 1:1 to about 1.5:1, such as about 1.25:1, or from about 1.2:1 to about 1.5:1, such as from about 1.3:1 to about 1.4:1, though other values are contemplated. Any of the foregoing numbers can be used singly to describe an open-ended range or in combination to describe a close-ended range.

A molar ratio of Cu to Pt (Ni:Pt) in the at least partially hollow Pt—Ni—Cu-M polyhedral nanoparticles (nanoframes) can be from about 0.5:1 to about 1:1, such as from about 0.6:1 to about 0.9:1, such as from about 0.7:1 to about 0.8:1, or from about 0.6:1 to about 0.8:1, such as from about 0.65:1 to about 0.75:1, though other values are contemplated. Any of the foregoing numbers can be used singly to describe an open-ended range or in combination to describe a close-ended range.

A molar ratio of M to Pt (M:Pt) in in the at least partially hollow Pt—Ni—Cu-M polyhedral nanoparticles (nanoframes) can be from about 0.5:1 to about 1:1, such as from about 0.6:1 to about 0.9:1, such as from about 0.7:1 to about 0.8:1, or from about 0.6:1 to about 0.8:1, such as from about 0.65:1 to about 0.75:1, though other values are contemplated. Any of the foregoing numbers can be used singly to describe an open-ended range or in combination to describe a close-ended range.

The at least partially hollow Pt—Ni—Cu-M polyhedral nanoparticles (nanoframes) can have a molar ratio of Ni to Cu to Pt to M (Ni:Cu:Pt:M) that is from about 1:0.5:1:0.5 to about 2:1:1:1, such as from about 1.2:0.6:1:0.6 to about 1.5:0.8:1:0.8, though other values are contemplated.

The mass % of Ni, mass % of Cu, mass % of Pt, mass % of Group 8-11 metal (M), and molar ratio of Ni:Cu:Pt:M in the at least partially hollow Pt—Ni—Cu-M polyhedral nanoparticles (nanoframes) is based on analysis of the products formed from the reaction.

In some aspects, the at least partially hollow Pt—Ni—Cu-M polyhedral nanoparticles (nanoframes) can have an average particle size that is from about 20 nm to about 500 μm, such as from about 30 nm to about 400 nm, such as from about 50 nm to about 250 nm, such as from about 75 nm to about 150 nm, or from about 20 nm to about 100 nm, such as from about 30 nm to about 80 nm, such as from about 40 nm to about 70 nm, such as from about 50 nm to about 60 nm, though other ranges are contemplated. Any of the foregoing numbers can be used singly to describe an open-ended range or in combination to describe a close-ended range. For polyhedral particles (e.g., metallic structures described herein), the average particle size is an equivalent edge length as measured by TEM.

In some aspects, the at least partially hollow Pt—Ni—Cu-M polyhedral nanoparticles (nanoframes) comprise hollow Pt—Ni—Cu-M dual-phase alloy polyhedral nanoparticles (nanoframes), hollow Pt—Ni—Cu-M single-phase alloy nanoparticles (nanoframes), or combinations thereof.

The at least partially hollow Pt—Ni—Cu-M polyhedral nanoparticles (nanoframes) can have various three-dimensional shapes (e.g., polyhedra) with a desired number of faces or sides. The number of sides can be in multiples of six starting with about 4 sides, and/or in multiples of eight starting with about 8 faces. The number of sides can be about 6, about 8, about 10, about 12, about 16, about 18, about 20, about 24, about 30, about 40, about 80, about 120, about 150, or about 180 sides.

The at least partially hollow Pt—Ni—Cu-M polyhedral nanoparticles are also referred to herein as Pt—Ni—Cu-M polyhedral nanoframes.

The Pt—Ni—Cu-M polyhedral nanoframes can have a variety of polyhedral structures such as cubic, tetrahedral, octahedral, dodecahedral, rhombic dodecahedral, decahedral, icosahedral, triangular prism, hexagonal prism, cuboctahedral, rod-shaped, bar-shaped, wire-shaped (or tube-like), or combinations thereof, as determined by X-ray diffraction. Other polyhedral structures are contemplated. In some aspects, the Pt—Ni—Cu-M polyhedral nanoframes comprise dodecahedral nanoframe, a rhombic dodecahedral nanoframe, a face-centered cubic nanoframe, hexagonal nanoframe, a cubic nanoframe, a tetrahedral nanoframe, an octahedral nanoframe, a decahedral nanoframe, an icosahedral nanoframe, a triangular prism nanoframe, a hexagonal prism nanoframe, a cuboctahedral nanoframe, a rod-shaped nanoframe, a bar-shaped nanoframe, a wire-shaped (or tube-like) nanoframe, or combinations thereof, as determined by X-ray diffraction. Other polyhedral nanoframe structures are contemplated.

The Pt—Ni—Cu-M polyhedral nanoframes be in the form of a core-shell structure where, for example, all four metal elements are in both the shell and the core. In some examples, the Pt and/or M metal atoms can be mainly distributed around the edge region (or in the shell) of the core-shell structure and the Cu and/or Ni metals can be mainly in the core of the core-shell structure as determined by elemental mapping using energy dispersive spectroscopy.

The Pt—Ni—Cu-M polyhedral nanoframes described herein can be characterized as having an interior encapsulated by a plurality of facets. The interior can be a partially hollow interior, a substantially hollow interior, or a hollow interior. The Pt—Ni—Cu-M polyhedral nanoframes can also have small pores in or among some or all of the facets. In some aspects, the small pores can allow small molecules to enter and reside in the interior or on the inner surface of the Pt—Ni—Cu-M polyhedral nanoframes so both the exterior surface and interior surface can provide a catalytic surface. Each of the facets can be made of a plurality of metal atoms. The facets can be solid or can be porous, having small pores that allow small molecules to pass between the outside of the nanostructure and the at least partially hollow interior.

The Pt—Ni—Cu-M polyhedral nanoframes can have any suitable number of facets. The number of faces can be about 4 faces or more, such as from about 4 facets to about 50 facets, such as from about 8 facets to about 40 facets, such as from about 12 facets to about 30 facets, such as from about 18 facets to about 20 facets. In some aspects, the number of facets can be 4, 8, 12, 15, 18, 20, 24, 30, 40, or 50 facets, though a higher or lower number of facets are contemplated. Each of the foregoing numbers can be preceded by the word “about,” “at least about,” “less than about,” or “more than about,” and any of the foregoing numbers can be used singly to describe an open-ended range or in combination to describe a close-ended range. Alternatively, and in some aspects, the Pt—Ni—Cu-M polyhedral nanoframes can have 4, 5, 6, 7, 8, 9, 10, 11, 12, 13, 14, 15, 16, 17, 18, 19, or 20 facets or more. Each of the foregoing numbers can be preceded by the word “about,” “at least about,” “less than about,” or “more than about,” and any of the foregoing numbers can be used singly to describe an open-ended range or in combination to describe a close-ended range. For example, the number of facets can be about 4, more than about 8, or from about 8 to about 20. Other numbers of facets are contemplated.

The at least partially hollow Pt—Ni—Cu-M polyhedral nanoparticles (e.g., the Pt—Ni—Cu-M polyhedral nanoframes) can be characterized as having a mass activity (in units of A/mg(Pt)) of greater than 0.12 such as greater than 0.2, greater than 0.44, greater than 0.5, greater than 1, greater than 1.5, greater than 2, greater than 3, greater than 4, greater than 6, greater than 10, or greater than 14, though higher or lower mass activities are contemplated. When the metal is not Pt, the units are A/mg(metal). Each of the foregoing numbers can be preceded by the word “about,” “at least about,” “less than about,” or “more than about,” and any of the foregoing numbers can be used singly to describe an open-ended range or in combination to describe a close-ended range. For example, the mass activity (in units of A/mg(Pt)) can be about 0.44, at least about 0.5, from about 1 to about 9, from about 0.8 to about 1.3, or from about 0.23 to about 13.8. The mass activity is determined at 0.9V with a reference to a reversible hydrogen electrode (V_{RHE}) as described in the Examples.

The at least partially hollow Pt—Ni—Cu-M polyhedral nanoparticles (e.g., the Pt—Ni—Cu-M polyhedral nanoframes) can have a loss in mass activity, after 30,000 cycles, that is less than 40%, such as less than 30%, such as less than 20%, such as less than 10%, such as less than 5% of its initial value. Loss in mass activity is determined at 0.9V with a reference to a reversible hydrogen electrode (V_{RHE}) as described in the Examples.

The at least partially hollow Pt—Ni—Cu-M polyhedral nanoparticles (e.g., the Pt—Ni—Cu-M polyhedral nanoframes) can have a loss in mass activity, after 100,000 cycles, that is less than 40%, such as less than 30%, such as less than 20%, such as less than 10%, such as less than 5% of its initial value.

In at least one aspect, Pt—Ni—Cu-M polyhedral nanoframes described herein can facilitate conversion reactions. In some aspects, one or more metallic structures described herein can be at least a portion of a catalyst composition. The catalyst composition can facilitate conversion reactions. As further described below, the nanostructures formed by aspects described herein can be useful for conversion reactions such as electrocatalytic conversion reactions. Illustrative, but non-limiting, examples of the electrocatalytic conversion reaction include oxygen reduction reaction (ORR), oxygen evolution reaction (OER), hydrogen evolution reaction (HER) such as the conversion of water into hydrogen, and the oxidation of alcohols.

### EXAMPLES

Various example, but non-limiting, multimetallic polyhedral nanoparticles were made according to some aspects described herein.

### Materials and Characterization Methods

### Materials

Copper chloride (CuCl₂, 99.0%), tributylphosphine (TBP, 99%), trioctylphosphine (TOP, 97%), oleylamine (OLA, 70%), nickel (II) (acetylacetonate) (Ni(acac)₂), cobalt (II) acetylacetonate (Co(acac)₂), palladium (II) acetylacetonate (Pd(acac)₂), silver nitrate (AgNO₃), tetrachloroauric(III) acid trihydrate (HAuCl₄·3H₂O, 99%), hexachloroplatinic acid hexahydrate (H₂PtCl₆·6H₂O), toluene (99.9%), acetone (99%), chloroform (99.9%), and 1-octadecene (ODE, 98%) were purchased from Sigma-Aldrich. Tetradecylamine (TDA, >96%) was purchased from TCI. Hexane (99%), methanol (99%), and ethanol (200 proof) were purchased from Fisher Chemicals. All chemicals were used as received. Milli-Q water was also used in the experiments.

### Characterization Methods

Surface morphologies were investigated using a scanning electron microscope (SEM, QUANTA FEG 650) from FEI, equipped with a field emitter as an electron source. X-ray Diffraction (XRD) patterns were collected using a Bruker D8 Advance X-ray diffractometer, employing Cu Kα radiation and operated at a tube voltage of 40 kV and a current of 40 mA.

Transmission electron microscopy (TEM) images were captured using an FEI Tecnai 20 microscope with an accelerating voltage of 200 kV. Energy Dispersive X-Ray (EDX) spectrometer mapping was acquired using the precision-oriented Titan³™ 80-300 S/TEM, operating at an acceleration of 300 kV. High-Angle Annular Dark-Field (HAADF) imaging was acquired using the precision-oriented Titan³™ 80-300 S/TEM, operating at an acceleration of 300 kV. HAADF was utilized to collect images (not shown) and observe hollow nanostructure and elemental composition.

All electrochemical measurements were measured on an electrochemical workstation (BioLogic) at room temperature (25° C.), using a three electrode electrochemical setup with a rotating disk electrode (RDE) system. A glassy carbon working electrode (GCE, 5 mm inner diameter, 0.196 cm²), a graphite rod counter electrode and a 3.0 M KCl saturated Ag/AgCl reference electrode were used for all the tests. All potentials are provided with respect to a reversible hydrogen electrode (RHE). The cyclic voltammetry (CV) scans were performed at a rate of 50 mV s⁻¹ near the thermodynamic potential of the H⁺/H₂ reaction. The potential at the zero-current point was chosen as the reaction potential of the hydrogen electrode. The potential at the zero current point was determined to be −0.287 V, so the potential measured with a Ag/AgCl electrode can be related by E (RHE)=E(Ag/AgCl)+0.287 V.

Before the electrochemical tests, samples were first loaded on a commercial carbon support (Vulcan XC-72R) to provide a dispersion. For comparison, a commercial platinum on carbon (Pt/C, 20 wt %, Sigma-Aldrich) was used as the baseline. Electrodes were prepared as follows. First, a catalyst ink was prepared by ultrasonicating a mixture of catalyst (about 4.0 mg), water (about 1.6 mL), isopropanol (about 0.4 mL), and Nafion™ solution (5 wt %, about 20 μL). Subsequently, about 10 μL of the catalyst ink was then spread onto the GCE surface using a micropipette and dried under ambient conditions. The Pt loading for all the catalyst samples was kept at about 20 μg/cm², which was validated by subsequent inductively coupled plasma-mass spectrometry (ICP-MS) evaluations. ICP-MS was performed using an inductively coupled mass spectrometer (Thermo Fisher Scientific iCAP™ RQ ICP-MS).

CV characterization for the catalysts, in an oxygen-deprived environment, was predominantly executed in the 0.1-1.1 V (versus RHE) potential range at a scan rate of 50 mV s⁻¹ scan rate in a nitrogen (N₂)-saturated 0.1 M perchloric acid (HClO₄) solution. Oxygen reduction reaction (ORR) polarization curves ORR polarization curves were recorded in an oxygen (O₂)-saturated 0.1 M HClO₄ electrolyte solution at a rotation speed of 1600 rpm and a scan rate of 20 mV s⁻¹. For the CV activation and ORR process of the example nanocatalysts, the ORR catalyst activity was conducted immediately after a ten-cycle CV activation. Durability testing was executed in an O₂-rich 0.1 M HClO₄ solution, spanning a voltage range from 0.6-1.0 V at ambient temperature. Following the testing, catalysts were retrieved by subjecting the GCE to ultrasonic waves in ethanol, facilitating subsequent structural and compositional scrutiny.

Electrochemically active surface area (ECSA) of the nanocatalysts was determined using the CV measurements. The ECSA was estimated by measuring the charge associated with HUPD adsorption (Q_{H}) between 0 and 0.37 V and assuming 210 μC/cm² for the adsorption of a monolayer of hydrogen on a Pt surface (q_{H}). The HUPD adsorption charge (Q_{H}) can be determined using Q_{H}=0.5×Q, where Q is the charge in the HUPD adsorption/desorption area obtained after double-layer correction. Then, the specific ECSA was calculated based on the following relation:

$$specific ECSA = {Q}_{H} / m \cdot {q}_{H}$$

where Q_{H} is the charge for HUPD adsorption, m is the loading amount of metal, and q_{H} is the charge required for monolayer adsorption of hydrogen on a Pt surface.

Mass activity was determined by the following procedure. In order to determine the mass-transport free kinetic current (Iₖ), the ORR measurements are conducted at the rotation speed of 1600 rpm. This rotation rate is used as the benchmark to compare the functionality of electrocatalysts and the ORR polarization limiting current ranges between 5.8×10⁻³ and 6×10⁻³ mA cm⁻². These limiting current values yield n=4 for the Levich and Levich-Koutecky plots. Furthermore, background current measurements are performed in deaerated electrolyte solution to account for capacitive current interferences. The difference between the experimentally measured current and the background current yields mass-transport corrected current. This current is used to evaluate mass- and area-specific activities of catalysts. Since at the limiting current the reaction kinetics occur very fast, the Koutecky-Levich equation can be rearranged as follows:

$${I}_{k} ( A ) = [ {I}_{lim} ( A ) \times I ( A ) ] / [ ( {I}_{lim} - l ) ( A ) ]$$

wherein: Iₗᵢₘ=id which is the measured diffusion limited current density; and Iₖ is the kinetic current (A). The I and Iₗᵢₘ are the values calculated from the anodic ORR polarization curve at E=0.9 V and E=0.4 V versus SHE, respectively. The Pt mass-specific (Iₘ) and area-specific (Is) activities are quantified at E=0.9 V versus SHE specifically because the contributions from mass-transport losses cannot be totally disregarded at the higher current densities detected below E=0.9 V. Therefore, the Pt mass-specific activity is calculated from the Iₖ and normalization to the Pt-loading of the GC disk electrode:

$${I}_{( 0.9 V )} ( A / mg ( P t ) ) = [ {I}_{k} ( A ) ] / [ {L}_{P t} ( mg ( Pt ) {cm}^{- 2} ) ( Ag ( {cm}^{2} ) ) ]$$

wherein: L_{Pt} is the working electrode catalyst loading (mg_{catalyst} cm⁻²) and Ag (cm²) is the geometric surface area of the glassy carbon electrode.

### Example 1: Synthesis of Example Metal-Amines (Precursor Stock Solutions)

### Example 1A. Synthesis of Copper-TDA (Cu-TDA) Precursor Stock Solution

Copper (I) chloride (100 mg, 1 mmol), TDA (240 mg), and ODE (2 mL) were mixed in a flask under an argon (Ar) or N₂ environment to form a solution/suspension. After degassing for 20 minutes, the solution/suspension was heated to 200° C. under Ar and/or N₂. After keeping the solution/suspension at this temperature for 10 minutes, the solution/suspension was cooled to room temperature. This Cu-TDA solution/suspension was utilized as a Cu-TDA precursor stock solution.

Various parameters were also investigated. Similar precursor stock solutions were investigated and can be prepared using other copper materials such as copper acetate or copper nitrate, among other copper materials, as well as other amines such as, for example, OLA, HDA, ODA, among other amines. Larger or smaller amounts of materials were investigated and can be used to prepare the precursor stock solution. For example, amounts of copper materials were investigated and can vary from, at least, the range of 0.37 mmol to 4.4 mmol with the amounts of amine (for example, TDA or others) varied accordingly.

### Example 1B. Synthesis of Nickel-OLA (Ni-OLA) Precursor Stock Solution

Ni(acac)₂ (128 mg, 0.5 mmol) and OLA (4 mL) were mixed in a flask under an Ar or N₂ environment to form a solution/suspension. The solution/suspension was then heated at 50-150° C. and shaken for 5 minutes. The solution/suspension was then cooled to room temperature. This Ni-OLA solution/suspension was utilized as a Ni-OLA precursor stock solution.

Various parameters were also investigated. Similar precursor stock solutions were investigated and can be prepared using other nickel materials such as, for example, nickel nitrate, nickel chloride, among other nickel salts. Various other amines, for example, TDA, HDA, ODA, among other amines were also investigated and can be used to prepare the nickel-amine stock solution. Larger or smaller amounts of materials were investigated and can be used to prepare the precursor stock solution. For example, amounts of nickel materials were investigated and can vary from, at least, the range of 0.12 mmol to 4.98 mmol with the amounts of amine (for example, OLA or others) varied accordingly.

### Example 1C. Synthesis of Platinum-OLA (Pt-OLA) Precursor Stock Solution

H₂PtCl₆·6H₂O (0.1 mmol, 51.7 mg) and OLA (3 mL) were mixed in a flask under an Ar or N₂ environment to form a solution/suspension. The solution/suspension was then heated at 50-150° C. and shaken for 5 minutes. The solution/suspension was then cooled to room temperature. This Pt-OLA solution/suspension was utilized as a Pt-OLA precursor stock solution.

Various parameters were also investigated. Similar precursor stock solutions were investigated and can be prepared using other platinum materials such as, for example, platinum chloride, sodium chloroplatinic acid, among others. Various other amines, for example, TDA, HDA, ODA, among other amines were also investigated and can be used to prepare the platinum-amine stock solution. Larger or smaller amounts of materials were investigated and can be used to prepare the precursor stock solution. For example, amounts of platinum materials were investigated and can vary from, at least, the range of 0.02 mmol to 1 mmol with the amounts of amine (for example, OLA or others) varied accordingly.

### Example 1D. Synthesis of Gold-OLA (Au-OLA) Precursor Stock Solution

Tetrachloroauric(III) acid trihydrate (10 mg, 0.025 mmol) and OLA (4 mL) were mixed in a flask under an Ar or N₂ environment to form a solution/suspension. The solution/suspension was then heated at 50-150° C. and shaken for 5 minutes. The solution/suspension was then cooled to room temperature. This Au-OLA solution/suspension was utilized as an Au-OLA precursor stock solution.

Various parameters were also investigated. Similar precursor stock solutions were investigated and can be prepared using other gold materials such as, for example, gold (I) chloride, sodium chloroauric acid, among others. Various other amines, for example, TDA, HDA, ODA, among other amines were also investigated and can be used to prepare the platinum-amine stock solution. Larger or smaller amounts of materials were investigated and can be used to prepare the precursor stock solution. For example, amounts of platinum materials were investigated and can vary from, at least, the range of 0.013 mmol to 1 mmol with the amounts of amine (for example, OLA or others) varied accordingly.

Other Group 8-11 metal-amine precursors can be prepared using this method, by utilizing other Group 8-11 metal salts such as, for example, silver nitrate, palladium chloride, cobalt acetylacetonate, iron acetylacetonate, among others.

### Example 2: Synthesis of Nickel-Copper (Ni—Cu) Polyhedral Nanoparticles

OLA (70%, 6.0 mL) was loaded in a 50 mL three-neck flask, the flask was fixed to a vertical gas flow column, and the OLA stirred. Oxygen was removed by Ar or N₂ blowing for 20 minutes while stirring. After degassing, TOP (1 mL) was injected into the three-neck flask under an Ar or N₂ environment and the resulting mixture was stirred. After degassing for 20 minutes, the mixture was rapidly heated to about 300° C. under Ar and/or N₂. Next, Cu-TDA precursor stock solution (0.5 mol/L, 2 mL) was injected into the three-neck flask, and the reaction solution was mixed until a red color was observed. The reaction solution was then cooled to a temperature of 120° C. and then the Ni-OLA precursor stock solution (2.0 mL) was injected, and the reaction solution was maintained at 120° C. After reaction for 1 hour at 120° C., the reaction solution was heated to 250° C. After about 5 minutes at 250° C., the heating mantle was turned off and the reaction solution was cooled to room temperature. 5 mL of hexane (or other hydrophobic solvent such as toluene and chloroform) and ethanol (5 mL) were added into the three-neck flask. The resulting Ni—Cu polyhedral nanoparticles were isolated by centrifuging at 4000 rpm for 5 minutes, and the supernatant was discarded. Another amount of hexane (10 mL) was added to the pellet and the mixture was centrifuged at 4000 rpm for 5 minutes. The washing procedure was repeated twice to remove unreacted precursors, solvent, and/or byproducts. The Ni—Cu polyhedral nanoparticles (NPs) were stored in a hydrophobic solvent (for example: hexane, toluene and chloroform) before further use and/or characterization.

The Ni—Cu polyhedral NPs were determined to be solids. FIG. 1B is a TEM image of the example solid Ni—Cu NPs. For this example, the Ni—Cu polyhedral NPs comprised about 60 mass % Ni and about 40 mass % Cu (molar ratio:Ni₆₀Cu₄₀).

Various parameters were also investigated and can be utilized to synthesize the Ni—Cu polyhedral NPs. For example, the temperature at which the Ni-amine precursor was injected can range from, at least, 80° C. to 320° C. After the injection, the reaction solution can be stirred at a temperature from, at least, 100° C. to 250° C. for a period of, at least, 1 minute to 1 hour. The temperature can then be heated at 250° C. Different Cu-amine precursor stock solutions and different Ni-amine precursor stock solutions were also investigated and can be used to synthesize the Ni—Cu polyhedral NPs, such as those Cu-amine precursor stock solutions and Ni-amine precursor stock solutions described above in Example 1A and Example 1B. Tributylphosphine (TBP) was also investigated and can be used instead of TOP to synthesize the Ni—Cu polyhedral NPs.

Other non-limiting Ni—Cu polyhedral NPs were made and had the following formulas: Ni₇₅Cu₂₅; Ni₅₅Cu₄₅; Ni₅₀Cu₅₀; Ni₄₀Cu₆₀; Ni₆₆Cu₃₃; and Ni₂₅Cu₇₅.

### Example 3: Synthesis of Platinum-Nickel-Copper (Pt—Ni—Cu) Polyhedral Nanoparticles

Ni—Cu polyhedral nanocrystals (30 mg) made in Example 2, 3.0 mL of OLA (70%), and octadecene (6 mL) were loaded in a 50 mL three-neck flask, the flask was fixed to a vertical gas flow column, and the resulting mixture was stirred. Oxygen was removed by Ar or N₂ blowing for 20 minutes while stirring. After degassing, the mixture was heated to 80° C., and then 4.0 mL of platinum ion solution (concentration of 0.5 M) was injected into the flask under Ar flow and the resulting mixture was stirred. The platinum ion solution for this example is the Pt-OLA precursor stock solution made in Example 1C. Next, the reaction solution was heated to 200° C. and kept at this temperature for 60 minutes while stirring. The heating mantle was turned off and the reaction solution was cooled to room temperature. 5 mL of hexane (or other hydrophobic solvent such as toluene and chloroform) and ethanol (5 mL) were added into the three-neck flask.

The resulting Pt—Ni—Cu polyhedral nanoparticles were isolated by centrifuging at 4000 rpm for 5 minutes, and the supernatant was discarded. Another amount of hexane (10 mL) was added to the pellet and the mixture was centrifuged at 4000 rpm for 5 minutes. The washing procedure was repeated twice to remove unreacted precursors, solvent, and/or byproducts. The Pt—Ni—Cu polyhedral NPs were stored in a hydrophobic solvent (for example: hexane, toluene and chloroform) before further use and/or characterization.

The Pt—Ni—Cu polyhedral NPs were determined to be solids. FIG. 1C is a TEM image of the example solid Pt—Ni—Cu NPs. The mass % of the metals in the Pt—Ni—Cu polyhedral NPs was: about 20 mass % Pt; about 50 mass % Ni; and about 30 mass % Cu. The Pt:Ni:Cu molar ratio of the Pt—Ni—Cu polyhedral NPs for this example was determined to be Pt₈Ni₅₇Cu₃₅.

Various parameters were also investigated and can be utilized to synthesize the Pt—Ni—Cu polyhedral NPs. For example, the temperature at which the Pt-amine precursor was injected can range from, at least, 80° C. to 320° C. After the injection, the reaction solution can be stirred at a temperature from, at least, 100° C. to 250° C. and for a period of, at least, 3 minutes to 5 hours. Different Pt-amine precursor stock solutions were also investigated and can be used to synthesize the Pt—Ni—Cu polyhedral NPs, such as those Pt-amine precursor stock solutions described above in Example 1C. The concentration of platinum ion solution may also vary from, at least, 0.05 M to 1.0 M.

Other non-limiting Pt—Ni—Cu polyhedral NPs were made and had the following formulas (mass ratio):Pt₅Ni₅₅Cu₄₀; Pt₁₀Ni₅₀Cu₄₀; Pt₁₅Ni₄₀Cu₄₅; Pt₂₀Ni₃₀Cu₅₀; Pt₃₀Ni₆₀Cu₃₀; and Pt₄₀Ni₁₀Cu₅₀.

### Example 4: Synthesis of Platinum-Nickel-Copper-Gold (Pt—Ni—Cu—Au) Polyhedral Nanoparticles

Pt—Ni—Cu polyhedral nanocrystals (30 mg) made in Example 3, 3.0 mL of OLA (70%), and octadecene (6 mL) were loaded in a 50 mL three-neck flask, the flask was fixed to a vertical gas flow column, and the resulting mixture was stirred. Oxygen was removed by Ar or N₂ blowing for 20 minutes while stirring. After degassing, the mixture was heated to 80° C., and then 4.0 mL of gold ion solution (concentration of 0.25 M) was injected into the flask under Ar flow and the resulting mixture was stirred. The gold ion solution for this example is the Au-OLA precursor stock solution made in Example 1D. Next, the reaction solution was heated to 200° C. and kept at this temperature for 60 minutes while stirring. The heating mantle was turned off and the reaction solution was cooled to room temperature. 5 mL of hexane (or other hydrophobic solvent such as toluene and chloroform) and ethanol (5 mL) were added into the three-neck flask. The resulting Pt—Ni—Cu—Au polyhedral nanoparticles were isolated by centrifuging at 4000 rpm for 5 minutes, and the supernatant was discarded. Another amount of hexane (10 mL) was added to the pellet and the mixture was centrifuged at 4000 rpm for 5 minutes. The washing procedure was repeated twice to remove unreacted precursors, solvent, and/or byproducts. The Pt—Ni—Cu—Au polyhedral NPs were stored in a hydrophobic solvent (for example: hexane, toluene and chloroform) before further use and/or characterization.

The Pt—Ni—Cu—Au polyhedral NPs were determined to be solids. FIG. 1D is a TEM image of the example solid Pt—Ni—Cu—Au NPs. The mass % of the metals in the Pt—Ni—Cu—Au polyhedral NPs was: about 20 mass % Pt; about 45 mass % Ni; about 25 mass % Cu; and about 10 mass % Au. The Pt:Ni:Cu:Au molar ratio of the Pt—Ni—Cu—Au polyhedral NPs for this example was determined to be Pt₈Ni₅₆Cu₃₁Au₅.

Various parameters were also investigated and can be utilized to synthesize the Pt—Ni—Cu—Au polyhedral NPs. For example, the temperature at which the Au-amine precursor was injected can range from, at least, 80° C. to 320° C. After the injection, the reaction solution can be stirred at a temperature from, at least, 100° C. to 250° C. and for a period of, at least, 3 minutes to 5 hours. Different gold-amine precursor stock solutions were also investigated and can be used to synthesize the Pt—Ni—Cu—Au polyhedral NPs, such as those Au-amine precursor stock solutions described above in Example 1D. The concentration of gold ion solution may also vary from, at least, 0.025 M to 1.0 M.

Other non-limiting Pt—Ni—Cu—Au polyhedral NPs were made and had the following formulas: Pt₁₅Ni₄₀Cu₄₀Au₅; Pt₁₀Ni₃₅Cu₄₅Au₁₀; Pt₂₀Ni₃₀Cu₃₀Au₂₀; Pt₂₅Ni₂₅Cu₃₅Au₁₅; Pt₃₀Ni₂₀Cu₃₀Au₂₀; and Pt₄₀Ni₂₀Cu₃₀Au₁₀.

### Example 5: Synthesis of Platinum-Nickel-Copper-Gold (Pt—Ni—Cu—Au) Hollow Polyhedral Nanoparticles

Pt—Ni—Cu—Au polyhedral nanocrystals (20 mg) made in Example 4, acetic acid (2.0 mL, concentration of 0.3 M), and water were loaded in a 25 mL flask, the flask was fixed to a vertical gas flow column, and the mixture was stirred. Oxygen was removed by Ar or N₂ blowing for 20 minutes while stirring. After degassing, the reaction solution was stirred at room temperature (15° C. to 25° C.) and kept at this temperature while stirring for a period of two days. The products were isolated by centrifuging at 3000 rpm for 2 minutes, and the supernatant was discarded. De-ionized water (5 mL) was added to the pellet and the mixture was centrifuged at 4000 rpm for 5 minutes. The washing procedure was repeated twice to remove unreacted precursors, solvent, and/or byproducts. The Pt—Ni—Cu—Au hollow polyhedral NPs (nanoframes) were stored in a hydrophilic solvent (for example: methanol, ethanol, and acetone) before further use and/or characterization.

The Pt—Ni—Cu—Au polyhedral NPs (nanoframes) were determined to be solids. FIG. 1D is a TEM image of the example solid Pt—Ni—Cu—Au NPs. The mass % of the metals in the Pt—Ni—Cu—Au polyhedral NPs was: about 30 mass % Pt; about 35 mass % Ni; about 20 mass % Cu; and about 15 mass % Au. The Pt:Ni:Cu:Au molar ratio of the Pt—Ni—Cu—Au polyhedral NPs for this example was determined to be Pt₁₅Ni₅₀Cu₂₈Au₇.

As shown in this non-limiting example, the mass % of Pt and the mass % of the Group 8-11 metal (Au) increased after acid treatment relative to those mass % values in the Pt—Ni—Cu—Au polyhedral NPs used as starting material. The mass % of Ni and the mass % of Cu decreased after acid treatment relative to those mass % values in the Pt—Ni—Cu—Au polyhedral NPs used as starting material.

Various parameters were also investigated and can be utilized to synthesize the Pt—Ni—Cu—Au hollow NPs (nanoframes). For example, the reaction temperature at which the Au-amine precursor was injected can range from, at least, 15° C. to 90° C., and the period for the reaction can vary from, at least, 1 minute to 7 days. Different acids were also investigated and can be utilized to synthesize the Pt—Ni—Cu—Au hollow NPs, such as acetic acid, carbonic acid, formic acid, propionic acid, sulfuric acid, phosphoric acid, nitric acid, perchloric acid, or hydrochloric acid. Different solvents were also investigated and can be utilized to synthesize the Pt—Ni—Cu—Au hollow NPs, such as ethanol, methanol, or acetone.

Larger or smaller amounts of materials were investigated and can be used to prepare the Pt—Ni—Cu—Au hollow NPs. For example, amounts of gold materials were investigated and can vary from, at least, the range of 0.03 mmol to 3.0 mmol with the amounts of acid (for example, acetic acid or others) varied accordingly.

Other non-limiting Pt—Ni—Cu—Au hollow NPs (nanoframes) were made and had the following formulas: Pt₂₀Ni₃₀Cu₃₅Au₁₅; Pt₂₅Ni₂₅Cu₃₀Au₂₅; Pt₃₀Ni₂₅Cu₂₅Au₂₀; Pt₃₅Ni₂₅Cu₂₅Au₁₅; Pt₄₀Ni₂₅Cu₂₀Au₁₅; and Pt₄₀Ni₂₀Cu₂₀Au₂₀.

### Example 6: Synthesis of Platinum-Nickel-Copper-Group 8-11 Metal (Pt—Ni—Cu-M) Hollow Polyhedral Nanoparticles

Other Pt—Ni—Cu-M hollow polyhedral NPs (nanoframes), where M is a Group 8-11 metal different from Pt, Ni, and Cu, were synthesized. These included metals such as Ag, Pd, Co, and Fe. Pt—Ni—Cu—Ag hollow NPs, Pt—Ni—Cu—Pd hollow NPs, Pt—Ni—Cu—Co hollow NPs, and Pt—Ni—Cu—Fe hollow NPs were made by utilizing the appropriate metal-amine precursor stock solution (made by, for example, the procedure outlined in Example 1D). Metal salts utilized to form the metal-amine precursor stock solutions included for example, silver nitrate, palladium chloride, cobalt acetylacetonate, iron acetylacetonate, among others. The appropriate precursor stock solution was then utilized to make the solid Pt—Ni—Cu-M polyhedral NPs according to the general procedure described in Example 4. The hollow Pt—Ni—Cu-M NPs were then made according to the general procedure described in Example 5.

Table 1 shows mass % and molar ratio of Pt, Ni, Cu, and M in various non-limiting hollow polyhedral nanoparticles (nanoframes) formed by aspects described herein. M is the Group 8-11 metal that is different from Pt, Ni, and Cu.

TABLE 1

| | Pt, | Ni, | Cu, | | |
|---|---|---|---|---|---|
| | mass | mass | mass | | Molar ratio of |
| Example | % | % | % | M, mass % | Pt:Ni:Cu:M |
| Pt—Ni—Cu—Au | 30 | 35 | 20 | 15 (M is Au) | Pt₁₅Ni₅₀Cu₂₈Au₇ |
| Pt—Ni—Cu—Ag | 30 | 30 | 25 | 15 (M is Ag) | Pt₁₅Ni₃₅Cu₃₂Ag₁₈ |
| Pt—Ni—Cu—Pd | 35 | 32 | 23 | 10 (M is Pd) | Pt₁₆Ni₄₄Cu₃₁Pd₉ |
| Pt—Ni—Cu—Co | 40 | 27 | 25 | 8 (M is Co) | Pt₁₈Ni₃₆Cu₃₄Co₁₂ |
| Pt—Ni—Cu—Fe | 40 | 33 | 20 | 7 (M is Fe) | Pt₁₈Ni₄₆Cu₂₇Fe₉ |

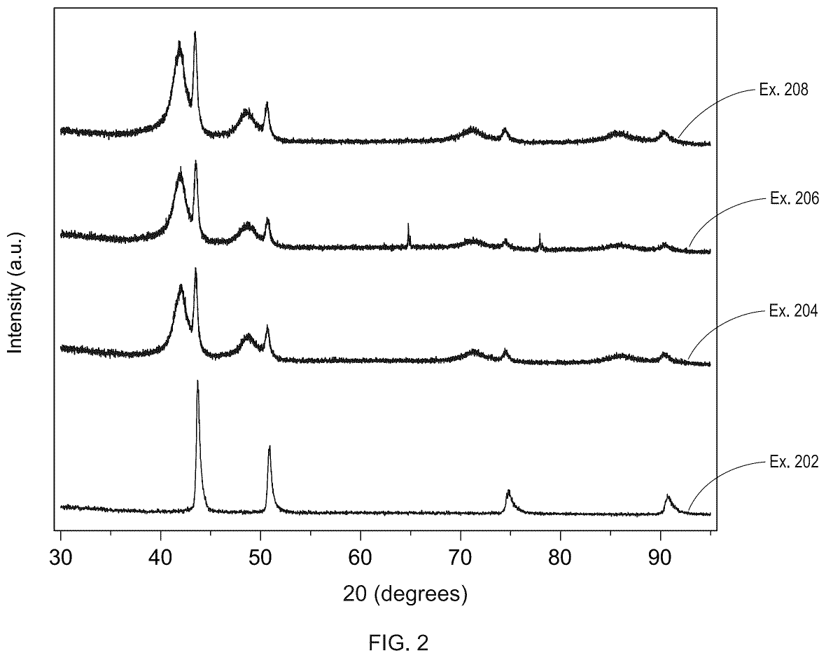

FIG. 2 presents an overlay of XRD patterns of products from various synthetic stages in the synthesis of Pt—Ni—Cu—Au nanostructures from Ni—Cu polyhedral NPs. In FIG. 2, Ex. 202 is the XRD pattern of the solid Ni—Cu polyhedral nanoparticles, Ex. 204 is the XRD pattern of the solid Pt—Ni—Cu polyhedral nanoparticles, Ex. 206 is the XRD pattern of the solid Pt—Ni—Cu—Au polyhedral nanoparticles, and Ex. 208 is the XRD pattern of the hollow Pt—Ni—Cu—Au hollow polyhedral nanoparticles. The initial materials, Cu—Ni polyhedral nanoparticles (Ex. 202) exhibited {111}, {200}, {220}, and {311}diffraction peaks which is consistent with a face centered cubic structure. Following the platinum ion treatment to form the solid Pt—Ni—Cu polyhedral nanoparticles (Ex. 204), the {111}symmetric peak of the Cu—Ni polyhedral structures bifurcated into two directional patterns, attributed to a Pt—Ni—Cu phase and a Ni—Cu-rich phase. While XRD results after the Au metal treatment (Ex. 206) and acid treatment (Ex. 208) indicate evident peak shifts, comprehensive composition characterizations were pursued via Energy Dispersive X-ray (EDX) microanalysis.

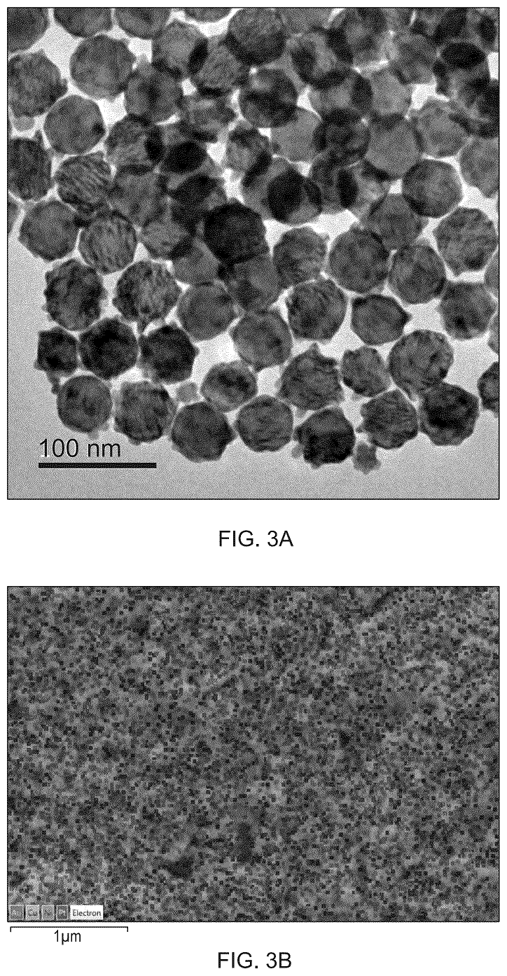

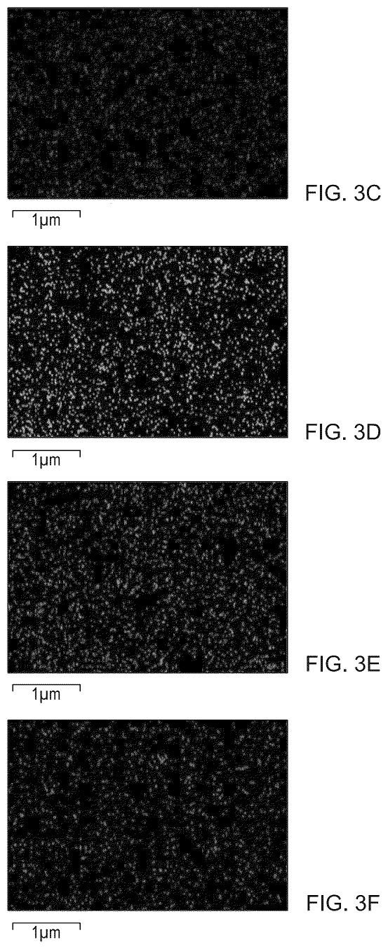

FIG. 3A is a TEM image example Pt—Ni—Cu—Au hollow nanocrystals formed according to aspects described herein. The average particle size of the example Pt—Ni—Cu—Au nanocrystals was determined to be about 52±3.1 nm. The size can be controlled by aspects described herein. For example, higher molar amounts and/or higher reaction temperatures can be utilized for faster nucleation, which in turn, can lead to a larger average particle size. FIGS. 3B-3F show elemental mapping images, collected by EDX, of example Pt—Ni—Cu—Au hollow nanocrystals. Specifically, FIG. 3B shows all four metal elements. FIGS. 3C, 3D, 3E, and 3F show the presence and location of Pt, Cu, Ni, and Au, respectively. The EDX confirms the composite nature of the Pt—Ni—Cu—Au hollow NPs, comprising elemental Pt, Cu, Ni, and Au.

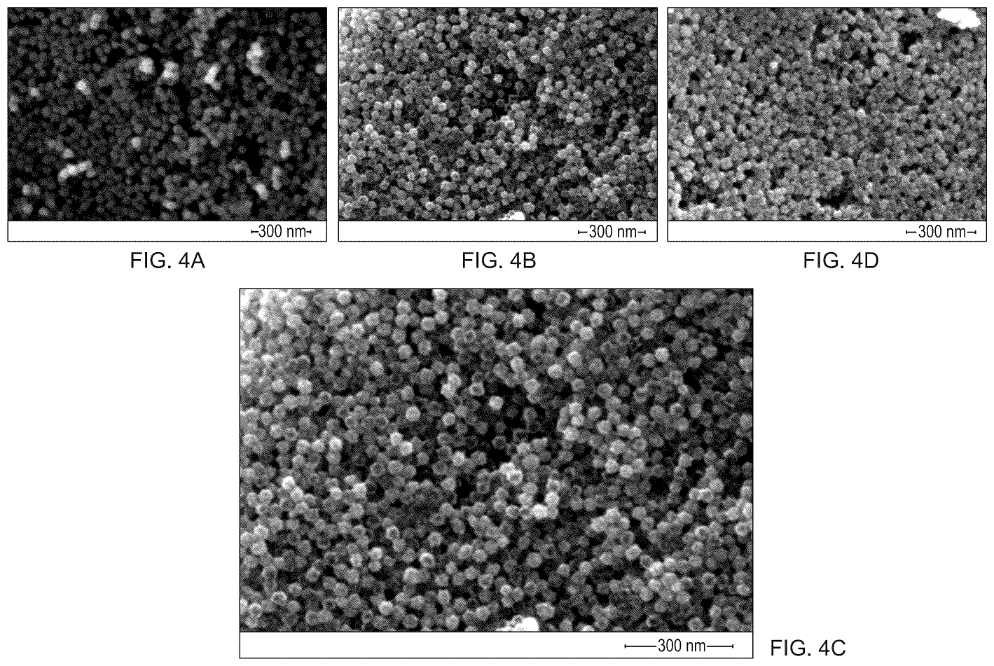

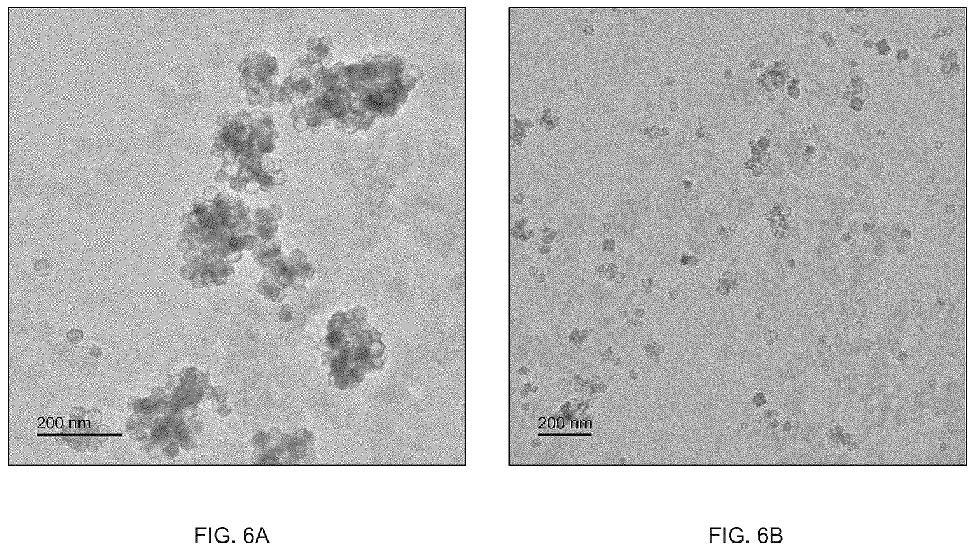

The synthesis methodology offers flexibility for modification. For example, aspects described can be utilized to form other quaternary hollow structures, for example, Pt—Ni—Cu—Ag hollow NPs, Pt—Ni—Cu—Pd hollow NPs, Pt—Ni—Cu—Co hollow NPs, and Pt—Ni—Cu—Fe hollow NPs among others. FIGS. 4A-4D show SEM images of selected quaternary hollow NPs, demonstrating the at least partially hollow nature of the nanostructures. Specifically, FIG. 4A shows example Pt—Ni—Cu—Ag hollow NPs, FIGS. 4B and 4C show example Pt—Ni—Cu—Pd hollow NPs, and FIG. 4D shows example Pt—Ni—Cu—Co hollow NPs. The SEM data is further corroborated by the TEM images in FIGS. 6A and 6B, which illustrate the contrasting visuals of each nanoparticle (with the void appearing white and the solid region appearing dark).

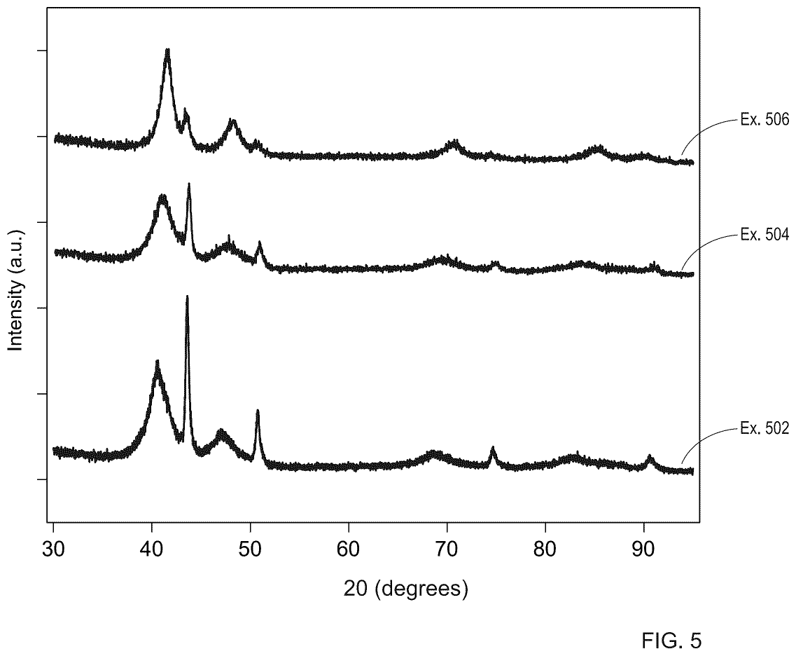

FIG. 5 presents an overlay of XRD patterns of products of example Pt—Ni—Cu—Ag hollow NPs (Ex. 502), Pt—Ni—Cu—Pd hollow NPs (Ex. 504), and Pt—Ni—Cu—Co hollow NPs (Ex. 506). When juxtaposed with Pt—Ni—Cu—Au, Pt—Ni—Cu—Ag, and Pt—Ni—Cu—Pd, the prominent diffraction peak of Pt—Ni—Cu—Co, positioned at about 41°, suggested that a majority of the residual transition metals (Cu, Ni, Co) were eradicated following the acid treatment. In contrast, the other three quaternary nanostructures exhibited a more pronounced diffraction peak, aligning with the Cu—Ni-rich alloy at 44°. While not wishing to be bound by any theory, this result may be due to the deposition of Au, Ag, and Pd on the Pt—Cu—Ni nanostructures hindering the acid-mediated removal of transition metal atoms.

In FIG. 5, the diffraction peaks shown at about 41° and 44° also show that the multimetallic alloy nanostructures can include dual-phase alloy nanoparticles, single-phase alloy nanoparticles, or combinations thereof. Here, the Pt—Ni—Cu—Co nanoparticles is closer to single-phase rather than dual-phase than the Pt—Ni—Cu—Ag nanoparticles.

Various multimetallic alloy nanostructures were supported onto carbon supports. TEM images of example carbon-supported multimetallic alloy nanostructures are shown in FIGS. 6A and 6B. Specifically, FIG. 6A is a TEM image of Pt—Ni—Cu—Pd hollow NPs supported on carbon (Pt—Ni—Cu—Pd/C) and FIG. 6B is a TEM image of Pt—Ni—Cu—Co hollow NPs supported on carbon (Pt—Ni—Cu—Co/C).

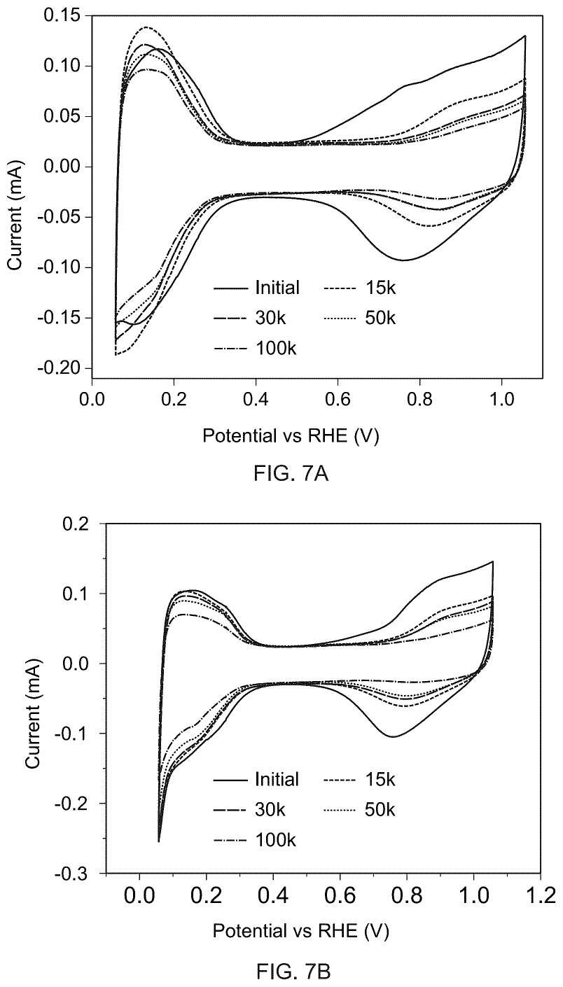

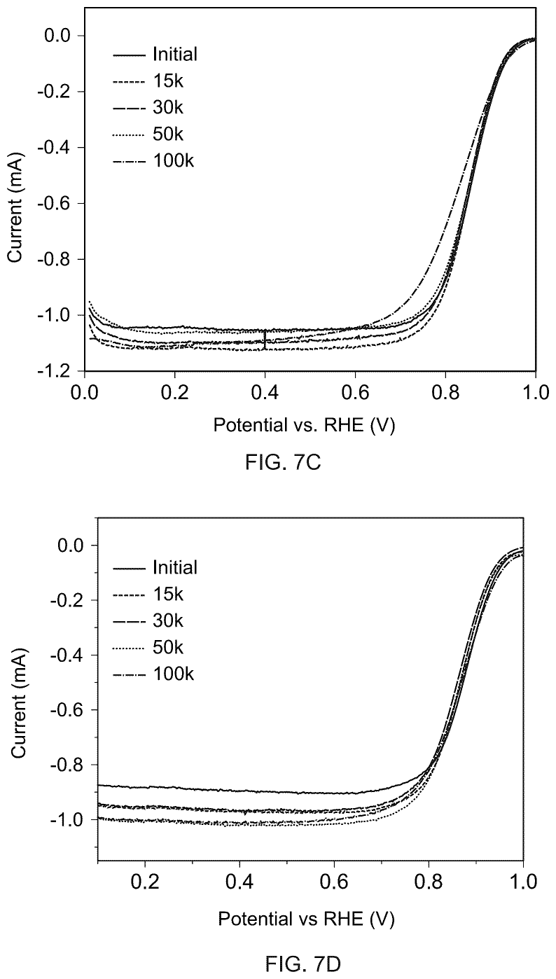

To ascertain the stability of catalysts formed by aspects described herein, Pt—Ni—Cu—Pd/C and Pt—Ni—Cu—Co/C hollow nanocatalysts were subjected to continuous voltage cycling between 0.6 and 1.0 V in a nitrogen-saturated 0.1 M HClO₄ solution. CV curves of Pt—Ni—Cu—Pd/C and Pt—Ni—Cu—Co/C are shown in FIG. 7A and FIG. 7B respectively. In FIGS. 7A and 7B, “k” means thousand. For example, 15 k means 15,000. Both carbon-supported nanocatalysts were subjected to 15,000 cycles, 30,000 cycles, 50,000 cycles, and 100,000 cycles. The oxygen reduction reaction (ORR) performance, tracked across 100,000 cycles, shows the electrochemically active surface area (ECSA) of Pt—Ni—Cu—Pd/C (FIG. 7A) and Pt—Ni—Cu—Co/C hollow nanocatalysts (FIG. 7B). The results indicated the excellent stability and durability of the catalysts even after 100,000 cycles. Interestingly, the ECSA of Pt—Ni—Cu—Pd/C nanocatalysts exhibited an increase post 30,000 cycles, while the ECSA of Pt—Ni—Cu—Co/C nanocatalysts remained relatively stable, even after 50,000 cycles.

The mass activities of Pt—Ni—Cu—Pd/C and Pt—Ni—Cu—Co/C hollow nanocatalysts were recorded at 0.94 A/mg(Pt) and 1.12 A/mg(Pt), respectively. These mass activities can be higher. Commercial Pt/C shows only 0.12 A/mg(Pt). Therefore, the results demonstrate the substantial improvement of mass activity and catalytic efficiency of nanocatalysts formed by aspects described herein over conventional, commercial catalysts. After 100,000 cycles, the mass activity of Pt—Ni—Cu—Co hollow nanocatalysts retained about 98% of its initial value, and Pt—Ni—Cu—Pd hollow nanocatalysts retained about 80%, as shown in the linear sweeping voltammetry curves of FIGS. 7C and 7D respectively. In FIGS. 7C and 7D, “k” means thousand. For example, 15 k means 15,000. Therefore the example Pt—Ni—Cu—Co hollow nanocatalysts had less than 5% loss in mass activity after 100,000 cycles, and the Pt—Ni—Cu—Pd hollow nanocatalysts had less than about 20% loss in mass activity after 100,000 cycles. Both hollow nanocatalysts surpass the DOE target which mandates a mass activity degradation of less than 40% post 30,000 cycles (2025 target) and 100,000 cycles (2030 target). Hollow nanocatalysts with different Group 8-11 metals (M), such as Ag, Au, or Fe, were also tested and showed results that surpassed the DOE targets.

Overall, aspects of the present disclosure provide a process for forming multimetallic alloy nanostructures. The data shows the excellent results enabled by solution-chemistry methodologies described herein. The versatile method is suitable for forming a variety of quaternary alloy nanocrystals. The examples illustrate that, for example, the quaternary alloy nanostructures surpass the catalytic efficiency of commercial Pt/C. The catalysts formed by aspects described herein maintain their performance even after 100,000 cycles and can be utilized as high entropy alloy nanoparticles.

### ASPECTS LISTING

The present disclosure provides, among others, the following aspects, each of which can be considered as optionally including any alternate aspects:
Clause A1. A process for forming hollow multimetallic nanostructures, the process comprising:
reacting a first mixture comprising a copper-amine, a phosphine, and a nickel-amine to form Ni—Cu polyhedral nanoparticles, the first mixture having: a molar ratio of the copper-amine to the phosphine that is from about 1000:1 to about 50:1; and a molar ratio of the nickel-amine to the copper-amine that is from about 99:1 to about 1:1;
reacting a second mixture comprising the Ni—Cu polyhedral nanoparticles and a platinum-amine at a temperature that is from about 80° C. to about 320° C. to form Pt—Ni—Cu polyhedral nanoparticles, the second mixture having a molar ratio of the Ni—Cu polyhedral nanoparticles to platinum-amine that is from about 500:1 to about 1:50;
reacting a third mixture comprising the Pt—Ni—Cu polyhedral nanoparticles and a Group 8-11 metal-amine at a temperature that is from about 80° C. to about 320° C. to form Pt—Ni—Cu-M polyhedral nanoparticles, the third mixture having a molar ratio of the Pt—Ni—Cu polyhedral nanoparticles to the Group 8-11 metal-amine that is from about 500:1 to about 1:10, and M is a Group 8-11 metal that is different from Pt, Ni, and Cu; and
reacting a fourth mixture comprising the Pt—Ni—Cu-M polyhedral nanoparticles and an acid at a temperature that is from about 15° C. to about 100° C. to form hollow multimetallic nanostructures, the fourth mixture having a molar ratio of the Pt—Ni—Cu-M polyhedral nanoparticles to acid that is from about 100:1 to about 1:100, wherein:
   the hollow multimetallic nanostructures comprise hollow Pt—Ni—Cu-M polyhedral nanoparticles; and
   the hollow Pt—Ni—Cu-M polyhedral nanoparticles have an average particle size that is from about 20 nm to about 500 nm.
Clause A2. The process of Clause A1, wherein the hollow Pt—Ni—Cu-M polyhedral nanoparticles comprise hollow Pt—Ni—Cu-M dual-phase alloy polyhedral nanoparticles, hollow Pt—Ni—Cu-M single-phase alloy nanoparticles, or combinations thereof.
Clause A3. The process of Clause A1 or Clause A2, wherein the Group 8-11 metal (M) comprises Fe, Ru, Os, Co, Rh, Ir, Pd, Ag, or Au.
Clause A4. The process of any one of Clauses A1-A3, wherein the Group 8-11 metal (M) comprises Au, Ag, Pd, Co, or Fe.
Clause A5. The process of any one of Clauses A1-A4, wherein the acid comprises acetic acid, carbonic acid, formic acid, propionic acid, sulfuric acid (H₂SO₄), phosphoric acid (H₃PO₄), nitric acid (HNO₃), perchloric acid (HClO₄), hydrochloric acid (HCl), or combinations thereof.
Clause A6. The process of any one of Clauses A1-A5, wherein the reacting the first mixture comprising the copper-amine, the phosphine, and the nickel-amine to form the Ni—Cu polyhedral nanoparticles comprises:
forming a mixture comprising the copper-amine and the phosphine;
heating the mixture to an injection temperature that is from about 80° C. to about 320° C.; introducing the nickel-amine to the heated mixture; and
reacting the resultant mixture at a temperature that is from about 80° C. to about 320° C. to form the Ni—Cu polyhedral nanoparticles.
Clause A7. The process of any one of Clauses A1-A6, wherein the phosphine comprises trimethylphosphine, triethylphosphine, tripropylphosphine, tributylphosphine, tripentylphosphine, trihexylphosphine, trioctylphosphine, tricyclohexylphosphine, diethylphosphine, dibutylphosphine, diphenylphosphine, dimethylethylphosphine, triphenylphosphine, or combinations thereof.
Clause A8. The process of any one of Clauses A1-A7, wherein the hollow Pt—Ni—Cu-M polyhedral nanoparticles comprise a polyhedral nanoframe comprising dodecahedral nanoframe, a rhombic dodecahedral nanoframe, a face-centered cubic nanoframe, a hexagonal nanoframe, or combinations thereof, as determined by X-ray diffraction.
Clause A9. The process of any one of Clauses A1-A8, wherein:
the molar ratio of the copper-amine to the phosphine in the first mixture is from about 400:1 to about 100:1;
the molar ratio of the nickel-amine to the copper-amine in the first mixture is from about 50:1 to about 1:1;
the molar ratio of the Ni—Cu polyhedral nanoparticles to the platinum-amine in the second mixture is from about 100:1 to about 20:1;
the molar ratio of the Pt—Ni—Cu polyhedral nanoparticles to the Group 8-11 metal-amine in the third mixture is from about 50:1 to about 20:1; and/or
the molar ratio of the Pt—Ni—Cu-M polyhedral nanoparticles to acid in the fourth mixture is from about 10:1 to about 1:50.
Clause A10. The process of any one of Clauses A1-A9, wherein:
the hollow Pt—Ni—Cu-M polyhedral nanoparticles, when supported on carbon, have a mass activity of greater than about 0.44 A/mg(Pt) at 0.9 V with a reference to a reversible hydrogen electrode (V_{RHE});
the hollow Pt—Ni—Cu-M polyhedral nanoparticles, when supported on carbon, has a loss in mass activity, after 100,000 cycles, that is less than about 25% of its initial mass activity; or
combinations thereof.
Clause A11. The process of any one of Clauses A1-A10, wherein the hollow Pt—Ni—Cu-M polyhedral nanoparticles consists of:
from about from about 10 mass % to 40 mass % of Pt based on a total mass % of the Pt, Ni, Co, and M in the hollow Pt—Ni—Cu-M polyhedral nanoparticles, the total mass % not to exceed 100 mass %;
from about from about 10 mass % to 40 mass % of Ni based on the total mass % of the Pt, Ni, Co, and M in the hollow Pt—Ni—Cu-M polyhedral nanoparticles;
from about from about 5 mass % to 30 mass % of Cu based on the total mass % of the Pt, Ni, Co, and M in the hollow Pt—Ni—Cu-M polyhedral nanoparticles; and
from about from about 5 mass % to 20 mass % of the Group 8-11 Metal (M) based on the total mass % of the Pt, Ni, Co, and M in the hollow Pt—Ni—Cu-M polyhedral nanoparticles.
Clause B1. A process for forming quaternary multimetallic alloy nanoframes, the process comprising:
reacting a first mixture comprising a copper-amine, a phosphine, and a nickel-amine to form Ni—Cu polyhedral nanoparticles;
reacting a second mixture comprising the Ni—Cu polyhedral nanoparticles and a platinum-amine at a temperature that is from about 150° C. to about 300° C. to form Pt—Ni—Cu polyhedral nanoparticles;
reacting a third mixture comprising the Pt—Ni—Cu polyhedral nanoparticles and a Group 8-11 metal-amine at a temperature that is from about 150° C. to about 300° C. to form Pt—Ni—Cu-M polyhedral nanoparticles, M is a Group 8-11 metal selected from the group consisting of Fe, Ru, Os, Co, Rh, Ir, Pd, Ag, and Au; and
reacting a fourth mixture comprising the Pt—Ni—Cu-M polyhedral nanoparticles and an acid at a temperature that is from about 15° C. to about 80° C. to form quaternary multimetallic alloy nanoframes, wherein:
   (a) the quaternary multimetallic alloy nanoframes comprise Pt—Ni—Cu-M polyhedral nanoframes;
   (b) a first mass % of the Group 8-11 metal in the Pt—Ni—Cu-M polyhedral nanoparticles is less than a second mass % of the Group 8-11 metal in the Pt—Ni—Cu-M polyhedral nanoframes; and wherein:
      (c1) the Pt—Ni—Cu-M polyhedral nanoframes have an average particle size that is from about 40 nm to about 350 nm;
      (c2) the Pt—Ni—Cu-M polyhedral nanoframes comprise rhombic dodecahedral nanoframes; or
      (c3) combinations thereof.
Clause B2. The process of Clause B1, wherein:
a molar ratio of the copper-amine to the phosphine in the first mixture is from about 400:1 to about 100:1;
a molar ratio of the nickel-amine to the copper-amine in the first mixture is from about 50:1 to about 1:1;
a molar ratio of the Ni—Cu polyhedral nanoparticles to the platinum-amine in the second mixture is from about 100:1 to about 20:1;
a molar ratio of the Pt—Ni—Cu polyhedral nanoparticles to the Group 8-11 metal-amine in the third mixture is from about 50:1 to about 20:1; and/or
a molar ratio of the Pt—Ni—Cu-M polyhedral nanoparticles to acid in the fourth mixture is from about 10:1 to about 1:50.
Clause B3. The process of Clause B1 or Clause B2, wherein the Group 8-11 metal (M) is selected from the group consisting of Au, Ag, Pd, Co, and Fe.
Clause B4. The process of any one of Clauses B1-B3, wherein the phosphine comprises an alkylphosphine.
Clause B5. The process of Clause B4, wherein the alkylphosphine comprises trioctylphosphine, tributylphosphine, or combinations thereof.
Clause C1. A process for forming quaternary multimetallic alloy nanoframes, the process comprising:
forming Ni—Cu polyhedral nanoparticles by:
   heating a first mixture comprising a copper-amine and an alkylphosphine to an injection temperature that is from about 80° C. to about 320° C., a molar ratio of the copper-amine to the alkylphosphine in the first mixture is from about 400:1 to about 100:1
   introducing a nickel-amine to the heated mixture; and
   reacting the resultant mixture at a temperature that is from about 80° C. to about 320° C. to form the Ni—Cu polyhedral nanoparticles;
reacting a second mixture comprising the Ni—Cu polyhedral nanoparticles and a platinum-amine at a temperature that is from about 150° C. to about 300° C. to form Pt—Ni—Cu polyhedral nanoparticles, a molar ratio of the Ni—Cu polyhedral nanoparticles to platinum-amine in the second mixture is from about 100:1 to about 20:1;
reacting a third mixture comprising the Pt—Ni—Cu polyhedral nanoparticles and a Group 8-11 metal-amine at a temperature that is from about 150° C. to about 300° C. to form Pt—Ni—Cu-M polyhedral nanoparticles, M is a Group 8-11 metal selected from the group consisting of Au, Ag, Pd, Co, or Fe, a molar ratio of the Pt—Ni—Cu polyhedral nanoparticles to the Group 8-11 metal-amine in the third mixture is from about 50:1 to about 20:1; and
reacting a fourth mixture comprising the Pt—Ni—Cu-M polyhedral nanoparticles and an acid to form quaternary multimetallic alloy nanoframes, a molar ratio of the Pt—Ni—Cu-M polyhedral nanoparticles to acid in the fourth mixture is from about 10:1 to about 1:50, wherein:
   (a) the quaternary multimetallic alloy nanoframes comprises Pt—Ni—Cu-M polyhedral nanoframes;
   (b) a first mass % of the Group 8-11 metal in the Pt—Ni—Cu-M polyhedral nanoparticles is less than a second mass % of the Group 8-11 metal in the Pt—Ni—Cu-M polyhedral nanoframes; and wherein:
      (c1) the Pt—Ni—Cu-M polyhedral nanoframes have an average particle size that is from about 20 nm to about 500 nm;
      (c2) the Pt—Ni—Cu-M polyhedral nanoframes comprise rhombic dodecahedral nanoframes; or
      (c3) combinations thereof.
Clause C2. The process of Clause C1, wherein the amine of the copper-amine, the nickel-amine, the copper-amine, the platinum-amine, and the Group 8-11 metal-amine comprises an alkylamine, the alkylamine being the same or different.
Clause C3. The process of Clause C2, wherein the alkylamine in each instance is, independently, tetradecylamine, oleylamine, octadecylamine, hexadecylamine, dodecylamine, and combinations thereof.
Clause C4. The process of any one of Clauses C1-C3, wherein the Pt—Ni—Cu-M polyhedral nanoframes comprise:
from about from about 10 mass % to 40 mass % of Pt based on a total mass % of the Pt, Ni, Co, and M in the Pt—Ni—Cu-M polyhedral nanoframes, the total mass % not to exceed 100 mass %;
from about from about 10 mass % to 40 mass % of Ni based on the total mass % of the Pt, Ni, Co, and M in the Pt—Ni—Cu-M polyhedral nanoframes;
from about from about 5 mass % to 30 mass % of Cu based on the total mass % of the Pt, Ni, Co, and M in the Pt—Ni—Cu-M polyhedral nanoframes; and/or
from about from about 5 mass % to 20 mass % of the Group 8-11 Metal (M) based on the total mass % of the Pt, Ni, Co, and M in the Pt—Ni—Cu-M polyhedral nanoframes.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a carbon source” include aspects comprising one, two, or more carbon sources, unless specified to the contrary or the context clearly indicates only one carbon source is included.

While the foregoing is directed to aspects of the present disclosure, other and further aspects of the disclosure may be devised without departing from the basic scope thereof, and the scope thereof is determined by the claims that follow.

What is claimed is:

1. A process for forming hollow multimetallic nanostructures, the process comprising:
reacting a first mixture comprising a copper-amine, a phosphine, and a nickel-amine to form Ni—Cu polyhedral nanoparticles, the first mixture having:
a molar ratio of the copper-amine to the phosphine that is from about 1000:1 to about 50:1; and
a molar ratio of the nickel-amine to the copper-amine that is from about 99:1 to about 1:1;
reacting a second mixture comprising the Ni—Cu polyhedral nanoparticles and a platinum-amine at a temperature that is from about 80° C. to about 320° C. to form Pt—Ni—Cu polyhedral nanoparticles, the second mixture having a molar ratio of the Ni—Cu polyhedral nanoparticles to platinum-amine that is from about 500:1 to about 1:50;
reacting a third mixture comprising the Pt—Ni—Cu polyhedral nanoparticles and a Group 8-11 metal-amine at a temperature that is from about 80° C. to about 320° C. to form Pt—Ni—Cu-M polyhedral nanoparticles, the third mixture having a molar ratio of the Pt—Ni—Cu polyhedral nanoparticles to the Group 8-11 metal-amine that is from about 500:1 to about 1:10, and M is a Group 8-11 metal that is different from Pt, Ni, and Cu; and
reacting a fourth mixture comprising the Pt—Ni—Cu-M polyhedral nanoparticles and an acid at a temperature that is from about 15° C. to about 100° C. to form hollow multimetallic nanostructures, the fourth mixture having a molar ratio of the Pt—Ni—Cu-M polyhedral nanoparticles to acid that is from about 100:1 to about 1:100, wherein:
the hollow multimetallic nanostructures comprise hollow Pt—Ni—Cu-M polyhedral nanoparticles; and
the hollow Pt—Ni—Cu-M polyhedral nanoparticles have an average particle size that is from about 20 nm to about 500 nm.

2. The process of claim 1, wherein the hollow Pt—Ni—Cu-M polyhedral nanoparticles comprise hollow Pt—Ni—Cu-M dual-phase alloy polyhedral nanoparticles, hollow Pt—Ni—Cu-M single-phase alloy nanoparticles, or combinations thereof.

3. The process of claim 1, wherein the Group 8-11 metal (M) comprises Fe, Ru, Os, Co, Rh, Ir, Pd, Ag, or Au.

4. The process of claim 1, wherein the Group 8-11 metal (M) comprises Au, Ag, Pd, Co, or Fe.

5. The process of claim 1, wherein the acid comprises acetic acid, carbonic acid, formic acid, propionic acid, sulfuric acid, phosphoric acid, nitric acid, perchloric acid, hydrochloric acid, or combinations thereof.

6. The process of claim 1, wherein the reacting the first mixture comprising the copper-amine, the phosphine, and the nickel-amine to form the Ni—Cu polyhedral nanoparticles comprises:
forming a mixture comprising the copper-amine and the phosphine;
heating the mixture to an injection temperature that is from about 80° C. to about 320° C.;
introducing the nickel-amine to the heated mixture; and
reacting the resultant mixture at a temperature that is from about 80° C. to about 320° C. to form the Ni—Cu polyhedral nanoparticles.

7. The process of claim 1, wherein the phosphine comprises trimethylphosphine, triethylphosphine, tripropylphosphine, tributylphosphine, tripentylphosphine, trihexylphosphine, trioctylphosphine, tricyclohexylphosphine, diethylphosphine, dibutylphosphine, diphenylphosphine, dimethylethylphosphine, triphenylphosphine, or combinations thereof.

8. The process of claim 1, wherein the hollow Pt—Ni—Cu-M polyhedral nanoparticles comprise a polyhedral nanoframe comprising dodecahedral nanoframe, a rhombic dodecahedral nanoframe, a face-centered cubic nanoframe, a hexagonal nanoframe, or combinations thereof, as determined by X-ray diffraction.

9. The process of claim 1, wherein:
the molar ratio of the copper-amine to the phosphine in the first mixture is from about 400:1 to about 100:1;
the molar ratio of the nickel-amine to the copper-amine in the first mixture is from about 50:1 to about 1:1;
the molar ratio of the Ni—Cu polyhedral nanoparticles to the platinum-amine in the second mixture is from about 100:1 to about 20:1;
the molar ratio of the Pt—Ni—Cu polyhedral nanoparticles to the Group 8-11 metal-amine in the third mixture is from about 50:1 to about 20:1;
the molar ratio of the Pt—Ni—Cu-M polyhedral nanoparticles to acid in the fourth mixture is from about 10:1 to about 1:50; or
combinations thereof.

10. The process of claim 1, wherein:
the hollow Pt—Ni—Cu-M polyhedral nanoparticles, when supported on carbon, have a mass activity of greater than about 0.44 A/mg(Pt) at 0.9 V with a reference to a reversible hydrogen electrode (V_{RHE});
the hollow Pt—Ni—Cu-M polyhedral nanoparticles, when supported on carbon, has a loss in mass activity, after 100,000 cycles, that is less than about 25% of its initial mass activity; or
combinations thereof.

11. The process of claim 1, wherein the hollow Pt—Ni—Cu-M polyhedral nanoparticles consists of:
from about from about 10 mass % to 40 mass % of Pt based on a total mass % of the Pt, Ni, Co, and M in the hollow Pt—Ni—Cu-M polyhedral nanoparticles, the total mass % not to exceed 100 mass %;
from about from about 10 mass % to 40 mass % of Ni based on the total mass % of the Pt, Ni, Co, and M in the hollow Pt—Ni—Cu-M polyhedral nanoparticles;
from about from about 5 mass % to 30 mass % of Cu based on the total mass % of the Pt, Ni, Co, and M in the hollow Pt—Ni—Cu-M polyhedral nanoparticles; and
from about from about 5 mass % to 20 mass % of the Group 8-11 Metal (M) based on the total mass % of the Pt, Ni, Co, and M in the hollow Pt—Ni—Cu-M polyhedral nanoparticles.

12. A process for forming quaternary multimetallic alloy nanoframes, the process comprising:
reacting a first mixture comprising a copper-amine, a phosphine, and a nickel-amine to form Ni—Cu polyhedral nanoparticles;
reacting a second mixture comprising the Ni—Cu polyhedral nanoparticles and a platinum-amine at a temperature that is from about 150° C. to about 300° C. to form Pt—Ni—Cu polyhedral nanoparticles;
reacting a third mixture comprising the Pt—Ni—Cu polyhedral nanoparticles and a Group 8-11 metal-amine at a temperature that is from about 150° C. to about 300° C. to form Pt—Ni—Cu-M polyhedral nanoparticles, M is a Group 8-11 metal selected from the group consisting of Fe, Ru, Os, Co, Rh, Ir, Pd, Ag, and Au; and
reacting a fourth mixture comprising the Pt—Ni—Cu-M polyhedral nanoparticles and an acid at a temperature that is from about 15° C. to about 80° C. to form quaternary multimetallic alloy nanoframes, wherein:
the quaternary multimetallic alloy nanoframes comprise Pt—Ni—Cu-M polyhedral nanoframes;
a first mass % of the Group 8-11 metal in the Pt—Ni—Cu-M polyhedral nanoparticles is less than a second mass % of the Group 8-11 metal in the Pt—Ni—Cu-M polyhedral nanoframes; and wherein:
the Pt—Ni—Cu-M polyhedral nanoframes have an average particle size that is from about 40 nm to about 350 nm;
the Pt—Ni—Cu-M polyhedral nanoframes comprise rhombic dodecahedral nanoframes; or
combinations thereof.

13. The process of claim 12, wherein:
a molar ratio of the copper-amine to the phosphine in the first mixture is from about 400:1 to about 100:1;
a molar ratio of the nickel-amine to the copper-amine in the first mixture is from about 50:1 to about 1:1;
a molar ratio of the Ni—Cu polyhedral nanoparticles to the platinum-amine in the second mixture is from about 100:1 to about 20:1;
a molar ratio of the Pt—Ni—Cu polyhedral nanoparticles to the Group 8-11 metal-amine in the third mixture is from about 50:1 to about 20:1;
a molar ratio of the Pt—Ni—Cu-M polyhedral nanoparticles to acid in the fourth mixture is from about 10:1 to about 1:50; or
combinations thereof.

14. The process of claim 12, wherein the Group 8-11 metal (M) is selected from the group consisting of Au, Ag, Pd, Co, and Fe.

15. The process of claim 12, wherein the phosphine comprises an alkylphosphine.

16. The process of claim 15, wherein the alkylphosphine comprises trioctylphosphine, tributylphosphine, or combinations thereof.

17. A process for forming quaternary multimetallic alloy nanoframes, the process comprising:
forming Ni—Cu polyhedral nanoparticles by:
heating a first mixture comprising a copper-amine and an alkylphosphine to an injection temperature that is from about 80° C. to about 320° C., a molar ratio of the copper-amine to the alkylphosphine in the first mixture is from about 400:1 to about 100:1
introducing a nickel-amine to the heated mixture; and
reacting the resultant mixture at a temperature that is from about 80° C. to about 320° C. to form the Ni—Cu polyhedral nanoparticles;
reacting a second mixture comprising the Ni—Cu polyhedral nanoparticles and a platinum-amine at a temperature that is from about 150° C. to about 300° C. to form Pt—Ni—Cu polyhedral nanoparticles, a molar ratio of the Ni—Cu polyhedral nanoparticles to platinum-amine in the second mixture is from about 100:1 to about 20:1;
reacting a third mixture comprising the Pt—Ni—Cu polyhedral nanoparticles and a Group 8-11 metal-amine at a temperature that is from about 150° C. to about 300° C. to form Pt—Ni—Cu-M polyhedral nanoparticles, M is a Group 8-11 metal selected from the group consisting of Au, Ag, Pd, Co, or Fe, a molar ratio of the Pt—Ni—Cu polyhedral nanoparticles to the Group 8-11 metal-amine in the third mixture is from about 50:1 to about 20:1; and
reacting a fourth mixture comprising the Pt—Ni—Cu-M polyhedral nanoparticles and an acid to form quaternary multimetallic alloy nanoframes, a molar ratio of the Pt—Ni—Cu-M polyhedral nanoparticles to acid in the fourth mixture is from about 10:1 to about 1:50, wherein:
the quaternary multimetallic alloy nanoframes comprise Pt—Ni—Cu-M polyhedral nanoframes;
a first mass % of the Group 8-11 metal in the Pt—Ni—Cu-M polyhedral nanoparticles is less than a second mass % of the Group 8-11 metal in the Pt—Ni—Cu-M polyhedral nanoframes; and wherein:
the Pt—Ni—Cu-M polyhedral nanoframes have an average particle size that is from about 20 nm to about 500 nm;
the Pt—Ni—Cu-M polyhedral nanoframes comprise rhombic dodecahedral nanoframes; or
combinations thereof.

18. The process of claim 17, wherein the amine of the copper-amine, the nickel-amine, the copper-amine, the platinum-amine, and the Group 8-11 metal-amine comprises an alkylamine, the alkylamine being the same or different.

19. The process of claim 18, wherein the alkylamine in each instance is, independently, tetradecylamine, oleylamine, octadecylamine, hexadecylamine, dodecylamine, and combinations thereof.

20. The process of claim 17, wherein the Pt—Ni—Cu-M polyhedral nanoframes comprise:
from about from about 10 mass % to 40 mass % of Pt based on a total mass % of the Pt, Ni, Co, and M in the Pt—Ni—Cu-M polyhedral nanoframes, the total mass % not to exceed 100 mass %;
from about from about 10 mass % to 40 mass % of Ni based on the total mass % of the Pt, Ni, Co, and M in the Pt—Ni—Cu-M polyhedral nanoframes;
from about from about 5 mass % to 30 mass % of Cu based on the total mass % of the Pt, Ni, Co, and M in the Pt—Ni—Cu-M polyhedral nanoframes;
from about from about 5 mass % to 20 mass % of the Group 8-11 Metal (M) based on the total mass % of the Pt, Ni, Co, and M in the Pt—Ni—Cu-M polyhedral nanoframes; or
combinations thereof.
